(19) United States
(12) Patent Application Publication
(10) Pub. No.: US 2017/0038344 A1
(43) Pub. Date: Feb. 9, 2017

(54) IMPROVEMENTS IN OR RELATING TO SONAR APPARATUS

(71) Applicant: HYDRASON SOLUTIONS LIMITED, Edinburgh (GB)

(72) Inventors: Christopher Glyn CAPUS, Edinburgh (GB); Yan PAILHAS, Edinburgh (GB); Keith Edgar BROWN, Edinburgh (GB)

(21) Appl. No.: 15/106,050

(22) PCT Filed: Dec. 18, 2014
(86) PCT No.: PCT/GB2014/053770

§ 371 Date: Jun. 17, 2016

(30) Foreign Application Priority Data
Dec. 20, 2013 (GB) 1322803.6

(51) Int. Cl. G01N 29/36; G01S 15/00; G01S 15/66; G01N 29/34

(52) U.S. Cl. CPC G01N 29/36; G01N 29/34; G01S 15/003; G01S 15/66

(57) ABSTRACT

A method of determining at least part of the structure of an object the method comprising the steps of providing at least one wideband acoustic signal transmission and reception device, the at least one wideband acoustic signal transmission and reception device being capable of transmitting and receiving one or more wideband acoustic signals, using the at least one wideband acoustic signal transmission and reception device to transmit at least one wideband acoustic signal towards at least a portion of the object, using the at least one wideband acoustic signal transmission and reception device to receive at least one wideband acoustic signal from the object, using the received at least one wideband acoustic signal from the object to createat least one acoustic data set, and analysing the at least one acoustic data set to determine the at least part of the structure of the object.

The present invention relates to a method and apparatus for determining at least part of the structure of an object through the use of wideband sonar.

Sonar systems are known to be capable of identifying and detecting objects. Some sonar systems use extensive signal processing techniques, which may include match filtering and compression, to give basic information about an object. However, known sonar systems are limited in the amount of information they can provide on an object.

For any object, the wideband echo is a rich source of information, derived from a complex summation of a number of scattering and resonance processes including components influenced by diffraction and refraction. These responses are therefore dependent in part on shape, structure and composition, including material properties. The high fidelity raw signal records generated with wide bandwidths and beam widths employed by the present invention enables structures and parts of structures to be identified from these complex echoes. This is in contrast to standard sonar, which operates on intensity alone. The processes involved in signal and image formation destroy the information used for identification and classification in the present invention.

The present invention directly links joint time and frequency responses to objects, structures and seafloor properties. Modelled and empirical relationships between time-frequency responses and general physical properties allow specific physical properties to be identified to get the information required from a specific wideband echo. This is inference from whole object responses, not looking for one specific resonance mode.

The apparatus and methods of the present invention operate with no need for contact or close proximity to the object. The present invention also uses wide beam width and wide bandwidth. The invention makes use of high fidelity raw data. The method of determining at least part of the structure of the object is by inference from whole object response, not looking for one specific resonance mode.

The present inventors have appreciated the shortcomings in these known sonar techniques.

According to a first aspect of the present invention there is provided a method of determining at least part of the structure of an object, the method comprising the steps of:
providing at least one wideband acoustic signal transmission and reception device, the at least one wideband acoustic signal transmission and reception device being capable of transmitting and receiving one or more wideband acoustic signals;
using the at least one wideband acoustic signal transmission and reception device to transmit at least one wideband acoustic signal towards at least a portion of the object;
using the at least one wideband acoustic signal transmission and reception device to receive at least one wideband acoustic signal from the object;
using the received at least one wideband acoustic signal from the object to create at least one acoustic data set; and
analysing the at least one acoustic data set to determine the at least part of the structure of the object.

In the context of the present application, the term “structure” is considered to include any one or more of the following features of the object: its shape, dimension(s), size, thickness, composition, physical state (e.g. solid, liquid, gas, plasma), material of construction, physical properties (e.g. absorption (physical), absorption (electromagnetic), absorption (acoustic), density, dielectric polarisability/permittivity, hardness, mass, sound speed in object (longitudinal for sound speed for fluid, gas and solid and transversal sound speed for solid only), content, surface roughness, topographical information, layering, heterogeneity, reflectivity and granularity.

Where the object comprises of a number of different components or materials, or where the object contains another object, such as a solid, liquid or gas, the term “structure” is considered to include any one or more of the following features of the object: its shape, the shape of each component, the dimensions of each component, the size of each component, the thickness of each component, the composition of each component, the physical state (e.g. solid, liquid, gas, plasma) of each component, the material of construction of each component, the physical properties (e.g. absorption (physical) of each component, the absorption (electromagnetic) of each component, the density of each component, the dielectric polarisability/permittivity of each component, the hardness of each component, the mass of each component, the sound speed in each object (longitudinal for sound speed for fluid, gas and solid and transversal sound speed for solid only), the content of each object, the surface roughness of each component, topographical information of each component, the arrangement of each component with respect to one another, the layering of each object, the heterogeneity of each object, the reflectivity of each object and the granularity of each object.

The method may therefore use the at least one wideband acoustic signal transmission and reception device to insonify at least a portion of the object. The method may also comprise the step of using the at least one wideband acoustic signal transmission and reception device to insonify the entire object.

The object and the at least one wideband acoustic signal transmission and reception device may be separated by a volume of water. In this case the at least one wideband acoustic signal is transmitted and received through the volume of water. Similarly, the object and the at least one wideband acoustic signal transmission and reception device may be separated by a solid, liquid or gas. The solid may be a wax medium. In these cases the at least one wideband acoustic signal is transmitted and received through the solid, liquid or gas. The method of determining at least part of the structure of the object is therefore a non-contact method, in which the at least one wideband acoustic signal transmission and reception device does not contact the object.

The at least one wideband acoustic signal transmission and reception device may have a quality factor (Q factor) of less than 5.0. The at least one wideband acoustic signal transmission and reception device may have a Q factor of less than 2.0. The at least one wideband acoustic signal transmission and reception device may have a Q factor of less than 1.0.

The at least one wideband acoustic signal transmission and reception device may be capable of transmitting and receiving wideband acoustic signals at more than 1 octave. The at least one wideband acoustic signal transmission and reception device may be capable of transmitting and receiving wideband acoustic signals at more than 2 octaves. The at least one wideband acoustic signal transmission and reception device may be capable of transmitting and receiving wideband acoustic signals at more than 3 octaves.

The at least one wideband acoustic signal transmission and reception device may have a high transmission and reception sensitivity. The at least one wideband acoustic signal transmission and reception device may have a reception sensitivity that allows reception of acoustic signals of between 3 dB and 30 dB below the primary echo level for the object of interest, which may be the specular echo. The at least one wideband acoustic signal transmission and reception device may therefore be capable of receiving wideband acoustic signals at dynamic ranges up to 96 dB for 16-bit systems and up to 144 dB for 24-bit systems and up to 192 dB for 32-bit systems. The efficiency of the at least one wideband acoustic signal transmission and reception device may be greater than 50%. The efficiency of the at least one wideband acoustic signal transmission and reception device may be greater than 65%.

The transmitted at least one wideband acoustic signal may have a frequency range between approximately 1 kHz and 2.5 MHz. The transmitted at least one wideband acoustic signal may have a frequency range between approximately 1 kHz and 1 MHz. The transmitted at least one wideband acoustic signal may have a frequency range between approximately 1 kHz and 300 kHz. The transmitted at least one wideband acoustic signal may have a frequency range between approximately 1 kHz and 200 kHz. The transmitted at least one wideband acoustic signal may have a frequency range between approximately 5 kHz and 200 kHz. The transmitted at least one wideband acoustic signal may have a frequency range between approximately 25 kHz and 1 MHz. The transmitted at least one wideband acoustic signal may have a frequency range between approximately 30 kHz and 150 kHz. The transmitted at least one wideband acoustic signal may have a frequency range between approximately 10 kHz and 200 kHz. The transmitted at least one wideband acoustic signal may have a frequency range between approximately 5 kHz and 100 kHz.

The transmitted at least one wideband acoustic signal may have a beam angle, or beam width, of between approximately 10 degrees to 120 degrees. The transmitted at least one wideband acoustic signal may have a beam angle of approximately 10 degrees, 20 degrees, 30 degrees, 40 degrees, 50 degrees, 60 degrees, 70 degrees, 80 degrees, 90 degrees, 100 degrees, 110 degrees and 120 degrees. The transmitted at least one wideband acoustic signal may have a beam angle, or beam width, of between approximately 1 degrees to 120 degrees.

A wide beam width, as described above, allows the whole of the object to be insonified by a single wideband acoustic signal (single pulse), or ensures that one wideband acoustic signal (single pulse) insonifies enough of the object for integration of multiple contributing echoes, i.e. enough acoustic data sets are created to assess the multiple returned signals from the object.

A wide beam width, as described above, allows multiple consecutive acoustic data sets of the object at different positions (views) to be created. This provides the characteristic changes in the wideband acoustic signals returned from the object to be used in the analysis of the acoustic data sets, including the feature tracking algorithms described below.

The transmitted at least one wideband acoustic signal may have a wave number k, where k=2π/λ, or k=2πf/c, and where λ is the wavelength of the acoustic signal in the material in which the acoustic signal is travelling, c is the speed of the acoustic signal in the material in which the acoustic signal is travelling, and f is the frequency of the acoustic signal in the material in which the acoustic signal is travelling, and the transmitted at least one wideband acoustic signal may be transmitted in the range of k.a of between 5 and 100 ([5:100]), where a is a dimension of the object, such as radius, diameter, length, wall thickness, or the like. The k.a range may alternatively be between 10 and 60 ([10:60]). The k.a range may alternatively be between approximately 1 and approximately 100 ([1:100]).

The method may include the further step of selectively optimising the k.a range of the at least one wideband acoustic signal in dependence on at least one predetermined, or known, feature of the object, or the environment in which the object is located. The method may include the further step of selectively optimising the k.a range of the at least one wideband acoustic signal in dependence on two or more predetermined, or known, features of the object, or the environment in which the object is located.

The at least one wideband acoustic signal transmission and reception device may be configurable to vary any one, or all, of the frequency, amplitude, transmission time and beam angle, or beam width, of the at least one wideband acoustic signal. The at least one wideband acoustic signal transmission and reception device may be configurable to vary any one, or all, of the frequency, amplitude, transmission time and beam angle, or beam width, of the at least one wideband acoustic signal during transmission and/or reception of the at least one wideband acoustic signal. In this arrangement the at least one wideband acoustic signal may be variable, or continuously variable, in terms of its frequency, amplitude, transmission time and beam angle, or beam width.

The method may comprise the further step of selectively optimising any one, or all, of the frequency, amplitude, transmission time and beam angle, or beam width, of the at least one wideband acoustic signal in dependence on at least one predetermined, or known, feature of the object, or the environment in which the object is located. The method may comprise the further step of selectively optimising any one, or all, of the frequency, amplitude, transmission time and beam angle, or beam width, of the at least one wideband acoustic signal in dependence on two or more predetermined, or known, features of the object, or the environment in which the object is located.

The at least one wideband acoustic signal transmission and reception device may be configurable to focus acoustic signal energy onto selected regions of the spectra. The at least one wideband acoustic signal transmission and reception device may be configurable to concentrate energy in part of the frequency containing maximum information for an object/environment and/or to minimise the impact of the environment which includes other objects.

The at least one wideband acoustic signal transmission and reception device may be used to transmit the at least one wideband acoustic signal towards the entire object. In this arrangement the entire object is insonified with the at least one wideband acoustic signal.

The at least one wideband acoustic signal transmission and reception device may be used to transmit the at least one wideband acoustic signal towards the object and at least a portion of the environment surrounding the object. In this arrangement the entire object and at least a part of the area around the object is insonified with the at least one wideband acoustic signal.

The at least one wideband acoustic signal may include at least one frequency chirp. The frequency chirp may be an up-chirp, where the frequency increases. Alternatively, the frequency may be a down-chirp, where the frequency decreases. The at least one wideband acoustic signal may include a first chirp having a first frequency range and a second chirp having a second frequency range. The first frequency range may be different from the second frequency range. The first frequency range may be higher or lower than the second frequency range.

The frequency chirp may be a linear chirp, where the frequency changes linearly. The frequency chip may be a non-linear chirp, where the frequency changes non-linearly. The frequency chip may be an exponential chirp, where the frequency changes exponentially.

The first frequency chirp and the second frequency chirp may overlap in time. The first frequency chirp and the second frequency chirp may overlap in time for more than 50% of the duration of the first chirp. The first frequency chirp and the second frequency chirp may overlap in time for more than 70% of the duration of the first chirp. The first frequency chirp and the second frequency chirp may overlap in time for more than 80% of the duration of the first chirp. The first frequency chirp and the second frequency chirp may overlap in time for more than 90% of the duration of the first chirp.

The at least one wideband acoustic signal may include a plurality of frequency chirps. The at least one wideband acoustic signal may include an up-chirp and a down-chirp. The at least one wideband acoustic signal may include two or more stacked frequency chirps. The at least one wideband acoustic signal may include a plurality of stacked frequency chirps. The at least one wideband acoustic signal may include a plurality of stacked up-chirps and/or stacked down-chirps.

The at least one wideband acoustic signal transmission and reception device may include a combined transmission and reception wideband acoustic signal transducer. In this arrangement the at least one wideband acoustic signal is transmitted and received from a single transducer.

The at least one wideband acoustic signal transmission and reception device may include a transmission wideband acoustic signal transducer and a reception wideband acoustic signal transducer. In this arrangement the at least one wideband acoustic signal is transmitted from a first transducer and the at least one wideband acoustic signal from the object is received at a second transducer.

The first transducer and the second transducer may be at the same location with respect to the object. The first transducer and the second transducer may be at different locations with respect to the object. The first or second transducer may be located adjacent, or within, the object. Both the first transducer and the second transducer may be located within the object.

The at least one wideband acoustic signal transmission and reception device may include a plurality of transmission wideband acoustic signal transducers and a plurality of reception wideband acoustic signal transducers. In this arrangement the at least one wideband acoustic signal is transmitted from the first transducers and the at least one wideband acoustic signal from the object is received at the second transducers. The at least one wideband acoustic signal transmission and reception device may be configurable to select which of the plurality of transmission and reception wideband acoustic signal transducers are used to transmit and receive the at least one wideband acoustic signal.

The at least one wideband acoustic signal transmission and reception device may be capable of transmitting and receiving a plurality of wideband acoustic signals.

The at least one wideband acoustic signal transmission and reception device may be capable of transmitting a plurality of wideband acoustic signals repeatedly. The repetition rate of the transmission of wideband acoustic signals may be variable. The repetition rate of the transmission of wideband acoustic signals is directly proportional to the distance between the at least one wideband acoustic signal transmission and reception device and the object.

The at least one wideband acoustic signal transmission and reception device may be capable of adjusting the repetition rate of the transmission of wideband acoustic signals to match the repetition rate of the transmission of wideband acoustic signals to the distance between the at least one wideband acoustic signal transmission and reception device and the object.

The at least one wideband acoustic signal transmission and reception device may be capable of transmitting and receiving a plurality of wideband acoustic signals at more than 1 octave. The at least one wideband acoustic signal transmission and reception device may be capable of transmitting and receiving a plurality of wideband acoustic signals at more than 2 octaves. The at least one wideband acoustic signal transmission and reception device may be capable of transmitting and receiving a plurality of wideband acoustic signals at more than 3 octaves.

The at least one wideband acoustic signal transmission and reception device may be configurable to select which of the plurality of transmission and reception wideband acoustic signal transducers are used to transmit and receive the plurality of wideband acoustic signals.

Each transmitted wideband acoustic signal may have a frequency range between approximately 1 kHz and 2.5 MHz. Each transmitted wideband acoustic signal may have a frequency range between approximately 1 kHz and 1 MHz. Each transmitted wideband acoustic signal may have a frequency range between approximately 1 kHz and 300 kHz. Each transmitted wideband acoustic signal may have a frequency range between approximately 1 kHz and 200 kHz. Each transmitted wideband acoustic signal may have a frequency range between approximately 5 kHz and 200 kHz. Each transmitted wideband acoustic signal may have a frequency range between approximately 25 kHz and 1 MHz. The transmitted at least one wideband acoustic signal may have a frequency range between approximately 30 kHz and 150 kHz. The transmitted at least one wideband acoustic signal may have a frequency range between approximately 10 kHz and 200 kHz. The transmitted at least one wideband acoustic signal may have a frequency range between approximately 5 kHz and 100 kHz.

Each transmitted wideband acoustic signal may have a beam angle, or beam width, of between approximately 10 degrees to 120 degrees. Each transmitted wideband acoustic signal may have a beam angle of approximately 10 degrees, 20 degrees, 30 degrees, 40 degrees, 50 degrees, 60 degrees, 70 degrees, 80 degrees, 90 degrees, 100 degrees, 110 degrees and 120 degrees. The transmitted at least one wideband acoustic signal may have a beam angle, or beam width, of between approximately 1 degrees to 120 degrees.

Each transmitted wideband acoustic signal may have a wave number k, where k=2π/λ, or k=2πf/c, and where λ is the wavelength of the acoustic signal in the material in which the acoustic signal is travelling, c is the speed of the acoustic signal in the material in which the acoustic signal is travelling, and f is the frequency of the acoustic signal in the material in which the acoustic signal is travelling, and each transmitted wideband acoustic signal may be transmitted in the range of k.a of between 5 and 100 ([5:100]), where a is a dimension of the object, such as radius, diameter, length, wall thickness, or the like. The k.a range may alternatively be between 10 and 60 ([10:60]). The k.a range may alternatively be between approximately 1 and approximately 100 ([1:100]).

The method may include the further step of selectively optimising the k.a range of each wideband acoustic signal in dependence on at least one predetermined, or known, feature of the object, or the environment in which the object is located. The method may include the further step of selectively optimising the k.a range of each wideband acoustic signal in dependence on two or more predetermined, or known, features of the object, or the environment in which the object is located.

The at least one wideband acoustic signal transmission and reception device may be configurable to vary any one, or all, of the frequency, amplitude, transmission time and beam angle, or beam width, of each of the wideband acoustic signals. The at least one wideband acoustic signal transmission and reception device may be configurable to vary any one, or all, of the frequency, amplitude, transmission time and beam angle, or beam width, of each of the wideband acoustic signals during transmission and/or reception of the wideband acoustic signals. In this arrangement each wideband acoustic signal may be variable, or continuously variable, in terms of its frequency, amplitude, transmission time and beam angle, or beam width.

The method may comprise the further step of selectively optimising any one, or all, of the frequency, amplitude, transmission time and beam angle, or beam width, of the each wideband acoustic signal in dependence on at least one predetermined, or known, feature of the object, or the environment in which the object is located. The method may comprise the further step of selectively optimising any one, or all, of the frequency, amplitude, transmission time and beam angle, or beam width, of the each wideband acoustic signal in dependence on two or more predetermined, or known, features of the object, or the environment in which the object is located.

The at least one acoustic data set may comprise at least one of the following features of the at least one wideband acoustic signal returned from the object: frequency, amplitude, phase delay, phase shift, distortion and shape of signal envelope in time domain.

Where the at least one acoustic data set comprises two or more wideband acoustic signals returned from the object (i.e. multiple echoes—primary and secondary echoes), the at least one acoustic data set comprises at least one of the following features of each wideband acoustic signal returned from the object: time delay, phase shift, relative frequency and relative amplitude.

The at least one acoustic data set may comprise the frequency, amplitude, phase delay, phase shift, distortion and shape of signal envelope in time domain of the at least one wideband acoustic signal returned from the object.

The at least one acoustic data set may comprise at least one of the following features of each wideband acoustic signal returned from the object: frequency, amplitude, phase delay, phase shift, distortion and shape of signal envelope in time domain. The at least one acoustic data set may comprise the frequency, amplitude, phase delay, phase shift, distortion and shape of signal envelope in time domain of each wideband acoustic signal returned from the object.

The at least one, or each, acoustic data set contains unprocessed data, which may be termed “raw” data. That is, the acoustic data analysed in the method has undergone no signal processing. The at least one, or each, acoustic data set may be complete “raw” data, or at least one “sub-band” of “raw” data. Where extraction of a “sub-band” of “raw” data is performed, the characteristic of the data of the at least one, or each, acoustic data set are persevered, i.e. the frequency, amplitude, phase delay and distortion characteristics remain unchanged.

The received at least one wideband acoustic signal from the object may be used to create two or more acoustic data sets. The method may comprise the further step of using the received at least one wideband acoustic signal from the object to create two or more acoustic data sets.

The method may comprise the further step of moving the at least one wideband acoustic signal transmission and reception device relative to the object during the transmission and reception of the at least one wideband acoustic signal. In this arrangement a plurality of acoustic data sets may be created from the received at least one wideband acoustic signal from the object.

The method may comprise the further step of moving the at least one wideband acoustic signal transmission and reception device relative to the object during the transmission and reception of the wideband acoustic signals. In this arrangement a plurality of acoustic data sets may be created from the received at least one wideband acoustic signal from the object.

The method may comprise using the at least one wideband acoustic signal transmission and reception device to perform various types of frequency generation. The method may comprise the use of parametric acoustic techniques to generate low frequency acoustic energy in the transmission medium, i.e. a low frequency acoustic signal. Parametric acoustic techniques may be used to generate low frequency wideband signals. Additional benefits arise from use of both the high and low frequencies generated in the parametric pulse formation. The higher frequencies with higher energy and more efficient range compression may be used for imaging. The lower frequencies provide capacity for wideband (>2 octaves) and ultra wideband (>3 octaves) low frequency pulses with constant beam width across the frequency range, ideally suited to identification/classification/recognition purposes.

The method may comprise the further step of storing the at least one, or each, acoustic data set in a data storage device. The data storage device may be located with the at least one wideband acoustic signal transmission and reception device.

The method may comprise the further step of analysing the at least one, or each, acoustic data set to form image data of the at least part of the structure of the object.

The method may comprise the further step of forming an image from the image data.

The step of analysing the at least one, or each, acoustic data set to form image data of the at least part of the structure of the object may comprise one or more of the following image processing techniques: image formation, sparse incoherent inverse beam image formation, signal compression, sliding window, median filtering, signal level adjustment, downsampling and noise removal.

The step of analysing the at least one acoustic data set to determine the at least part of the structure may include analysing at least one of the frequency data, amplitude data, phase delay data, time delay data and distortion data contained therein. The method may include the further step of analysing each acoustic data set to determine the at least part of the structure by analysing at least one of the frequency data, amplitude data, phase delay data, time delay data and distortion data contained in each acoustic data set.

The step of analysing the at least one acoustic data set to determine the at least part of the structure may include the use of one or more algorithms. The algorithms may include time-domain algorithms, frequency-domain algorithms, time-frequency spaces algorithms or fractional-domain algorithms. The step of analysing the at least one acoustic data set to determine the at least part of the structure may include the use of a combination of time-domain algorithms, frequency-domain algorithms, time-frequency spaces algorithms or fractional-domain algorithms.

The at least part of the structure of the object may be determined from the time domain structure of the acoustic data set, the frequency domain structure over time of the acoustic data set, or the frequency domain structure over aspect of the acoustic data set. The method may comprise the further step of analysing the at least one acoustic data set to determine the time domain structure, the frequency domain structure over time, or the frequency domain structure over aspect.

The at least part of the structure of the object may be determined from the time domain structure of each acoustic data set, the frequency domain structure over time of each acoustic data set, or the frequency domain structure over aspect of each acoustic data set. The method may comprise the further step of analysing each acoustic data set to determine the time domain structure, the frequency domain structure over time, or the frequency domain structure over aspect.

The step of analysing each acoustic data set to determine the at least part of the structure may include identifying one or more common features between data sets. The step of analysing each acoustic data set to determine the at least part of the structure may include comparing, fusing, or tracking each common feature between data sets. This may involve the use of “adaptive thresholds” and “min-max” approaches. This may also involve the use of Kalman filters, extended Kalman filters, Markov models, Markov chain Monte Carlo methods, state-space models, particle filters, finite set methods, multi-hypothesis trackers.

The step of analysing each acoustic data set to determine the at least part of the structure may include identifying the following features from the, or each, acoustic data set: (i) time domain: relative amplitudes, phase delays, time delays between returned acoustic wideband signals, signal distortions; (ii) frequency domain: relative spectral amplitudes, relative phase, wavelet features, scattering operator features, spectral texture features, including positions and scales of peaks and notches, relative positions and scales of peaks and notches and co-occurrence features. The frequency domain features may be analysed for the full frequency band. Additionally, or alternatively, the frequency domain features may be analysed for one or more sub-bands of the full frequency band.

The step of analysing each acoustic data set to determine the at least part of the structure may include fusing and tracking data across a plurality of data sets. The data sets may be classified or compared to one or more of: feature values generated from other wideband “training” data, which may be empirical, real-time, modelled (analytic, numerical) or legacy data. The features are classified or compared to one or more of: feature values generated or collated from other wideband ‘training’ data: empirical, real-m time (in-situ), modelled (analytic, numerical), legacy data. Alternatively an inversion method can be applied: using any available prior information (if available) or information generated from features (as above) to relate the observed responses to the physical processes of echo formation which are in turn determined by the structure (as previously defined) of the object and/or environment/seabed and the known transmission pulse.

The step of analysing each acoustic data set to determine the at least part of the structure may include identifying one or more different features between data sets, as outlined above.

The step of analysing the at least one acoustic data set to determine the at least part of the structure may include comparing the at least one acoustic data set with one or more predetermined, or known, acoustic data sets. The one or more predetermined, or known, acoustic data sets may include empirical data, previously gathered data (legacy data), or data obtained from mathematical modelling.

The step of analysing the at least one acoustic data set to determine the at least part of the structure may be carried out by computer executing a computer program. The computer program may include the one or more algorithms.

The step of analysing the at least one acoustic data set to determine the at least part of the structure may be carried out in real-time. Alternatively, the step of analysing the at least one acoustic data set to determine the at least part of the structure may be carried out at a later date, or “off line”.

The method may comprise the further step of modifying the at least one wideband acoustic signal transmitted from the at least one wideband acoustic signal transmission and reception device in dependence on the results obtained from the analysis of the at least one, or each, acoustic data set. In this arrangement the method may comprise the steps of (i) transmitting a first wideband acoustic signal, (ii) analysing a first acoustic data set created from the wideband acoustic signals returned from the object, (iii) modifying the at least one wideband acoustic signal transmitted from the at least one wideband acoustic signal transmission and reception device in dependence on the first acoustic data set, (iv) transmitting a second (modified) wideband acoustic signal from the at least one wideband acoustic signal transmission and reception device, and (v) analysing a second acoustic data set created from the wideband acoustic signals returned from the object. The signals transmitted by the at least one wideband acoustic signal transmission and reception device may be the full wideband signal, or a sub-band of this full wideband signal.

In this arrangement the at least one, or each, wideband acoustic signal may be intelligently adapted to optimise the method of determining the at least part of the structure of the object.

The method may further comprise the step of determining the location, or geolocation of the at least part of the structure of the object.

The method may further comprise the step of determining substantially the entire structure of the object.

The method may further comprise the step of identifying the object. The identification of the object may be determined by determining a plurality of parts of the structure of the object.

The method may further comprise the step of classifying the object. The classification of the object may be determined by determining a plurality of parts of the structure of the object.

The method may further comprise the step of assessing the condition of the object. The step of assessing the condition of the object may comprise determining a plurality of parts of the structure of the object, and optionally comparing this with predetermined, or known, data on the part of the structure.

The object may include a number of different parts, or components. In this case, the method may determine at least a part of the structure of each part, or component, of the object.

The object may contain, or be filled with, a solid, liquid or gas. In this case, the method may determine at least a part of the structure of the object and the material contained therein.

The object may be an area of land, such as the seabed. In this case the method may determine at least a part of the structure of the seabed, such as physical properties of the sediment, surface hardness, grain size of sand, layering information, surface roughness and topographical information.

The object may be any one of, or combination of, the following: a manmade object or a natural object, such as a seabed or environment. Manmade objects may include: underwater structures and assets, vessels (powered and unpowered); containers (hollow and filled); communications cables; power cables; wrecks; debris; waste; spillages; dumped materials, buried and partially buried objects. Natural objects may include: seabed materials and structures, rocks, corals, fish, crustaceans, buried and burrowing animals, other flora and fauna; detritus; and debris.

The method may comprise the further step of providing a plurality of wideband acoustic signal transmission and reception devices, each wideband acoustic signal transmission and reception device being capable of transmitting and receiving one or more wideband acoustic signals.

According to a second aspect of the present invention there is provided an apparatus for determining at least part of the structure of an object comprising:
at least one wideband acoustic signal transmission and reception device, the at least one wideband acoustic signal transmission and reception device being operable to transmit and receive one or more wideband acoustic signals;
an acoustic data set module, the acoustic data set module being capable of receiving at least one wideband acoustic signal from the object to create at least one acoustic data set; and
an acoustic data set analysis module, the acoustic data set analysis module being operable to analyse the at least one acoustic data set to determine the at least part of the structure of the object.

Embodiments of the second aspect of the invention may include one or more features of the first aspect of the invention or its embodiments. Similarly, embodiments of the first aspect of the invention may include one or more features of the second aspect of the invention or its embodiments.

The apparatus may therefore insonify at least a portion of the object. The apparatus may also insonify the entire object.

The object and the at least one wideband acoustic signal transmission and reception device may be separated by a volume of water. In this case the at least one wideband acoustic signal is transmitted and received through the volume of water. Similarly, the object and the at least one wideband acoustic signal transmission and reception device may be separated by a solid, liquid or gas. The solid may be a wax medium. In these cases the at least one wideband acoustic signal is transmitted and received through the solid, liquid or gas. The method of determining at least part of the structure of the object is therefore a non-contact method, in which the at least one wideband acoustic signal transmission and reception device does not contact the object.

The at least one wideband acoustic signal transmission and reception device may have a quality factor (Q factor) of less than 5.0. The at least one wideband acoustic signal transmission and reception device may have a Q factor of less than 2.0. The at least one wideband acoustic signal transmission and reception device may have a Q factor of less than 1.0.

The at least one wideband acoustic signal transmission and reception device may be capable of transmitting and receiving wideband acoustic signals at more than 1 octave. The at least one wideband acoustic signal transmission and reception device may be capable of transmitting and receiving wideband acoustic signals at more than 2 octaves. The at least one wideband acoustic signal transmission and reception device may be capable of transmitting and receiving wideband acoustic signals at more than 3 octaves.

The at least one wideband acoustic signal transmission and reception device may have a high transmission and reception sensitivity. The at least one wideband acoustic signal transmission and reception device may have a reception sensitivity that allows reception of acoustic signals of between 3 dB and 30 dB below the primary echo level for the object of interest. The at least one wideband acoustic signal transmission and reception device may be capable of receiving wideband acoustic signals at dynamic ranges up to 96 dB for 16-bit systems and up to 144 dB for 24-bit systems and up to 192 dB for 32-bit systems. The efficiency of the at least one wideband acoustic signal transmission and reception device may be greater than 50%. The efficiency of the at least one wideband acoustic signal transmission and reception device may be greater than 65%.

The transmitted at least one wideband acoustic signal may have a frequency range between approximately 1 kHz and 2.5 MHz. The transmitted at least one wideband acoustic signal may have a frequency range between approximately 1 kHz and 1 MHz. The transmitted at least one wideband acoustic signal may have a frequency range between approximately 1 kHz and 300 kHz. The transmitted at least one wideband acoustic signal may have a frequency range between approximately 1 kHz and 200 kHz. The transmitted at least one wideband acoustic signal may have a frequency range between approximately 5 kHz and 200 kHz. The transmitted at least one wideband acoustic signal may have a frequency range between approximately 25 kHz and 1 MHz. The transmitted at least one wideband acoustic signal may have a frequency range between approximately 30 kHz and 150 kHz. The transmitted at least one wideband acoustic signal may have a frequency range between approximately 10 kHz and 200 kHz. The transmitted at least one wideband acoustic signal may have a frequency range between approximately 5 kHz and 100 kHz.

The transmitted at least one wideband acoustic signal may have a beam angle, or beam width, of between approximately 10 degrees to 120 degrees. The transmitted at least one wideband acoustic signal may have a beam angle of approximately 10 degrees, 20 degrees, 30 degrees, 40 degrees, 50 degrees, 60 degrees, 70 degrees, 80 degrees, 90 degrees, 100 degrees, 110 degrees and 120 degrees. The transmitted at least one wideband acoustic signal may have a beam angle, or beam width, of between approximately 1 degrees to 120 degrees.

The transmitted at least one wideband acoustic signal may have a wave number k, where k=2π/λ, or k=2πf/c, and where λ is the wavelength of the acoustic signal in the material in which the acoustic signal is travelling, c is the speed of the acoustic signal in the material in which the acoustic signal is travelling, and f is the frequency of the acoustic signal in the material in which the acoustic signal is travelling, and the transmitted at least one wideband acoustic signal may be transmitted in the range of k.a of between 5 and 100 ([5:100]), where a is a dimension of the object, such as radius, diameter, length, wall thickness, or the like. The k.a range may alternatively be between 10 and 60 ([10:60]). The k.a range may alternatively be between approximately 1 and approximately 100 ([1:100]).

The at least one wideband acoustic signal transmission and reception device may be configurable to selectively optimise the k.a range of the at least one wideband acoustic signal in dependence on at least one predetermined, or known, feature of the object, or the environment in which the object is located. The at least one wideband acoustic signal transmission and reception device may be configurable to selectively optimise the k.a range of the at least one wideband acoustic signal in dependence on two or more predetermined, or known, features of the object, or the environment in which the object is located.

The at least one wideband acoustic signal transmission and reception device may be configurable to vary any one, or all, of the frequency, amplitude, transmission time and beam angle, or beam width, of the at least one wideband acoustic signal. The at least one wideband acoustic signal transmission and reception device may be configurable to vary any one, or all, of the frequency, amplitude, transmission time and beam angle, or beam width, of the at least one wideband acoustic signal during transmission and/or reception of the at least one wideband acoustic signal. In this arrangement the at least one wideband acoustic signal may be variable, or continuously variable, in terms of its frequency, amplitude, transmission time and beam angle, or beam width.

The at least one wideband acoustic signal transmission and reception device may be configurable to optimise any one, or all, of the frequency, amplitude, transmission time and beam angle, or beam width, of the at least one wideband acoustic signal in dependence on at least one predetermined, or known, feature of the object, or the environment in which the object is located. The at least one wideband acoustic signal transmission and reception device may be configurable to optimise any one, or all, of the frequency, amplitude, transmission time and beam angle, or beam width, of the at least one wideband acoustic signal in dependence on two or more predetermined, or known, features of the object, or the environment in which the object is located.

The at least one wideband acoustic signal transmission and reception device may be configurable to focus acoustic signal energy onto selected regions of the spectra. The at least one wideband acoustic signal transmission and reception device may be configurable to concentrate energy in part of the frequency containing maximum information for an object/environment and/or to minimise the impact of the environment which includes other objects.

The at least one wideband acoustic signal transmission and reception device may be configurable to transmit the at least one wideband acoustic signal towards the entire object. In this arrangement the entire object is insonified with the at least one wideband acoustic signal.

The at least one wideband acoustic signal transmission and reception device may be configurable to transmit the at least one wideband acoustic signal towards the object and at least a portion of the environment surrounding the object. In this arrangement the entire object and at least a part of the area around the object is insonified with the at least one wideband acoustic signal.

The at least one wideband acoustic signal may include at least one frequency chirp. The frequency chirp may be an up-chirp, where the frequency increases. Alternatively, the frequency may be a down-chirp, where the frequency decreases. The at least one wideband acoustic signal may include a first chirp having a first frequency range and a second chirp having a second frequency range. The first frequency range may be different from the second frequency range. The first frequency range may be higher or lower than the second frequency range.

The frequency chirp may be a linear chirp, where the frequency changes linearly. The frequency chip may be a non-linear chirp, where the frequency changes non-linearly. The frequency chip may be an exponential chirp, where the frequency changes exponentially.

The first frequency chirp and the second frequency chirp may overlap in time. The first frequency chirp and the second frequency chirp may overlap in time for more than 50% of the duration of the first chirp. The first frequency chirp and the second frequency chirp may overlap in time for more than 70% of the duration of the first chirp. The first frequency chirp and the second frequency chirp may overlap in time for more than 80% of the duration of the first chirp. The first frequency chirp and the second frequency chirp may overlap in time for more than 90% of the duration of the first chirp.

The at least one wideband acoustic signal may include a plurality of frequency chirps. The at least one wideband acoustic signal may include an up-chirp and a down-chirp. The at least one wideband acoustic signal may include two or more stacked frequency chirps. The at least one wideband acoustic signal may include a plurality of stacked frequency chirps. The at least one wideband acoustic signal may include a plurality of stacked up-chirps and/or stacked down-chirps.

The at least one wideband acoustic signal transmission and reception device may include a combined transmission and reception wideband acoustic signal transducer. In this arrangement the at least one wideband acoustic signal is transmitted and received from a single transducer.

The at least one wideband acoustic signal transmission and reception device may include a transmission wideband acoustic signal transducer and a reception wideband acoustic signal transducer. In this arrangement the at least one wideband acoustic signal is transmitted from a first transducer and the at least one wideband acoustic signal from the object is received at a second transducer.

The first transducer and the second transducer may be at the same location with respect to the object. The first transducer and the second transducer may be at different locations with respect to the object. The first or second transducer may be located adjacent, or within, the object. Both the first transducer and the second transducer may be located within the object.

The at least one wideband acoustic signal transmission and reception device may include a plurality of transmission wideband acoustic signal transducers and a plurality of reception wideband acoustic signal transducers. In this arrangement the at least one wideband acoustic signal is transmitted from the first transducers and the at least one wideband acoustic signal from the object is received at the second transducers. The at least one wideband acoustic signal transmission and reception device may be configurable to select which of the plurality of transmission and reception wideband acoustic signal transducers are used to transmit and receive the at least one wideband acoustic signal.

The at least one wideband acoustic signal transmission and reception device may be configurable to transmit and receive a plurality of wideband acoustic signals.

The at least one wideband acoustic signal transmission and reception device may be capable of transmitting and receiving a plurality of wideband acoustic signals at more than 1 octave. The at least one wideband acoustic signal transmission and reception device may be capable of transmitting and receiving a plurality of wideband acoustic signals at more than 2 octaves. The at least one wideband acoustic signal transmission and reception device may be capable of transmitting and receiving a plurality of wideband acoustic signals at more than 3 octaves.

The at least one wideband acoustic signal transmission and reception device may be configurable to select which of the plurality of transmission and reception wideband acoustic signal transducers are used to transmit and receive the plurality of wideband acoustic signals.

Each transmitted wideband acoustic signal may have a frequency range between approximately 1 kHz and 2.5 MHz. Each transmitted wideband acoustic signal may have a frequency range between approximately 1 kHz and 1 MHz. Each transmitted wideband acoustic signal may have a frequency range between approximately 1 kHz and 300 kHz. Each transmitted wideband acoustic signal may have a frequency range between approximately 1 kHz and 200 kHz. Each transmitted wideband acoustic signal may have a frequency range between approximately 5 kHz and 200 kHz. Each transmitted wideband acoustic signal may have a frequency range between approximately 25 kHz and 1 MHz. The transmitted at least one wideband acoustic signal may have a frequency range between approximately 30 kHz and 150 kHz. The transmitted at least one wideband acoustic signal may have a frequency range between approximately 10 kHz and 200 kHz. The transmitted at least one wideband acoustic signal may have a frequency range between approximately 5 kHz and 100 kHz.

Each transmitted wideband acoustic signal may have a beam angle, or beam width, of between approximately 10 degrees to 120 degrees. Each transmitted wideband acoustic signal may have a beam angle of approximately 10 degrees, 20 degrees, 30 degrees, 40 degrees, 50 degrees, 60 degrees, 70 degrees, 80 degrees, 90 degrees, 100 degrees, 110 degrees and 120 degrees. The transmitted at least one wideband acoustic signal may have a beam angle, or beam width, of between approximately 1 degrees to 120 degrees.

Each transmitted wideband acoustic signal may have a wave number k, where k=2π/λ, or k=2πf/c, and where λ is the wavelength of the acoustic signal in the material in which the acoustic signal is travelling, c is the speed of the acoustic signal in the material in which the acoustic signal is travelling, and f is the frequency of the acoustic signal in the material in which the acoustic signal is travelling, and each transmitted wideband acoustic signal may be transmitted in the range of k.a of between 5 and 100 ([5:100]), where a is a dimension of the object, such as radius, diameter, length, wall thickness, or the like. The k.a range may alternatively be between 10 and 60 ([10:60]). The k.a range may alternatively be between approximately 1 and approximately 100 ([1:100]).

The at least one wideband acoustic signal transmission and reception device may be configurable to selectively optimise the k.a range of each wideband acoustic signal in dependence on at least one predetermined, or known, feature of the object, or the environment in which the object is located. The at least one wideband acoustic signal transmission and reception device may be configurable to selectively optimise the k.a range of each wideband acoustic signal in dependence on two or more predetermined, or known, features of the object, or the environment in which the object is located.

The at least one wideband acoustic signal transmission and reception device may be configurable to vary any one, or all, of the frequency, amplitude, transmission time and beam angle, or beam width, of each of the wideband acoustic signals. The at least one wideband acoustic signal transmission and reception device may be configurable to vary any one, or all, of the frequency, amplitude, transmission time and beam angle, or beam width, of each of the wideband acoustic signals during transmission and/or reception of the wideband acoustic signals. In this arrangement each wideband acoustic signal may be variable, or continuously variable, in terms of its frequency, amplitude, transmission time and beam angle, or beam width.

The at least one wideband acoustic signal transmission and reception device may be configurable to optimise any one, or all, of the frequency, amplitude, transmission time and beam angle, or beam width, of the each wideband acoustic signal in dependence on at least one predetermined, or known, feature of the object, or the environment in which the object is located. The at least one wideband acoustic signal transmission and reception device may be configurable to optimise any one, or all, of the frequency, amplitude, transmission time and beam angle, or beam width, of the each wideband acoustic signal in dependence on two or more predetermined, or known, features of the object, or the environment in which the object is located.

The at least one acoustic data set may comprise at least one of the following features of the at least one wideband acoustic signal returned from the object: frequency, amplitude, phase delay, phase shift, distortion and shape of signal envelope in time domain.

Where the at least one acoustic data set comprises two or more wideband acoustic signals returned from the object (i.e. multiple echoes—primary and secondary echoes), the at least one acoustic data set comprises at least one of the following features of each wideband acoustic signal returned from the object: time delay, phase shift, relative frequency and relative amplitude.

The at least one acoustic data set may comprise the frequency, amplitude, phase delay, phase shift, distortion and shape of signal envelope in time domain of the at least one wideband acoustic signal returned from the object.

The at least one acoustic data set may comprise at least one of the following features of each wideband acoustic signal returned from the object: frequency, amplitude, phase delay, phase shift, distortion and shape of signal envelope in time domain. The at least one acoustic data set may comprise the frequency, amplitude, phase delay, phase shift, distortion and shape of signal envelope in time domain of each wideband acoustic signal returned from the object.

The at least one, or each, acoustic data set contains unprocessed data, which may be termed “raw” data. That is, the acoustic data analysed in the method has undergone no signal processing. The at least one, or each, acoustic data set may be complete “raw” data, or at least one “sub-band” of “raw” data. Where extraction of a “sub-band” of “raw” data is performed, the characteristic of the data of the at least one, or each, acoustic data set are persevered, i.e. the frequency, amplitude, phase delay and distortion characteristics remain unchanged.

The acoustic data set module may be capable of creating two or more acoustic data sets from the at least one wideband acoustic signal from the object.

The apparatus may be configured such that the at least one wideband acoustic signal transmission and reception device is capable of moving relative to the object during the transmission and reception of the at least one wideband acoustic signal. In this arrangement a plurality of acoustic data sets may be created from the received at least one wideband acoustic signal from the object.

The at least one wideband acoustic signal transmission and reception device may be capable of performing various types of frequency generation. The at least one wideband acoustic signal transmission and reception device may be capable of generating low frequency acoustic energy in the transmission medium, i.e. a low frequency acoustic signal.

The apparatus may further comprise a data storage device for storing the at least one, or each, acoustic data set. The data storage device may be located with the at least one wideband acoustic signal transmission and reception device.

The acoustic data set analysis module may be operable to form image data of the at least part of the structure of the object from the at least one, or each, acoustic data set.

The apparatus may further comprise an image formulation module for forming an image from the image data.

The step of analysing the at least one, or each, acoustic data set to form image data of the at least part of the structure of the object may comprise one or more of the following image processing techniques: image formation, sparse incoherent inverse beam image formation, signal compression, sliding window, median filtering, signal level adjustment, downsampling and noise removal.

The acoustic data set analysis module may be capable of analysing at least one of the frequency data, amplitude data, phase delay data, time delay data and distortion data contained in the at least one acoustic data set. The acoustic data set analysis module may be capable of analysing at least one of the frequency data, amplitude data, phase delay data, time delay data and distortion data contained in each acoustic data set.

The acoustic data set analysis module may be configurable to use of one or more algorithms. The algorithms may include time-domain algorithms, frequency-domain algorithms, time-frequency spaces algorithms or fractional-domain algorithms. The acoustic data set analysis module may be configurable to use a combination of time-domain algorithms, frequency-domain algorithms, time-frequency spaces algorithms or fractional-domain algorithms.

The at least part of the structure of the object may be determined from the time domain structure of the acoustic data set, the frequency domain structure over time of the acoustic data set, or the frequency domain structure over aspect of the acoustic data set. The acoustic data set analysis module may be capable of determining the time domain structure, the frequency domain structure over time, or the frequency domain structure over aspect.

The at least part of the structure of the object may be determined from the time domain structure of each acoustic data set, the frequency domain structure over time of each acoustic data set, or the frequency domain structure over aspect of each acoustic data set. The acoustic data set analysis module may be capable of analysing each acoustic data set to determine the time domain structure, the frequency domain structure over time, or the frequency domain structure over aspect.

The acoustic data set analysis module may be capable of identifying one or more common features between data sets of each acoustic data set. The acoustic data set analysis module may be capable of comparing, fusing, or tracking each common feature between data sets of each acoustic data set. This may involve the use of “adaptive thresholds” and “min-max” approaches. This may also involve the use of Kalman filters, extended Kalman filters, Markov models, Markov chain Monte Carlo methods, state-space models, particle filters, finite set methods, multi-hypothesis trackers.

The analysis of each acoustic data set to determine the at least part of the structure may include identifying the following features from the, or each, acoustic data set: (i) time domain: relative amplitudes, phase delays, time delays between returned acoustic wideband signals, signal distortions; (ii) frequency domain: relative spectral amplitudes, relative phase, wavelet features, scattering operator features, spectral texture features, including positions and scales of peaks and notches, relative positions and scales of peaks and notches and co-occurrence features. The frequency domain features may be analysed for the full frequency band. Additionally, or alternatively, the frequency domain features may be analysed for one or more sub-bands of the full frequency band.

The analysis of each acoustic data set to determine the at least part of the structure may include fusing and tracking data across a plurality of data sets. The data sets may be classified or compared to one or more of: feature values generated from other wideband “training” data, which may be empirical, real-time, modelled (analytic, numerical) or legacy data. Alternatively an inversion method can be applied: using any available prior information (if available) or information generated from features (as above) to relate the observed responses to the physical processes of echo formation which are in turn determined by the structure (as previously defined) of the object and/or environment/seabed and the known transmission pulse.

The acoustic data set analysis module may be capable of comparing the at least one acoustic data set with one or more predetermined, or known, acoustic data sets to determine the at least part of the structure. The one or more predetermined, or known, acoustic data sets may include empirical data, previously gathered data (legacy data), or data obtained from mathematical modelling.

The acoustic data set analysis module may include a computer to analyse the at least one acoustic data set to determine the at least part of the structure. The computer may be capable of executing a computer program. The computer program may include the one or more algorithms.

The acoustic data set analysis module may analyse the at least one acoustic data set to determine the at least part of the structure in real-time. Alternatively, the acoustic data set analysis module may analyse the at least one acoustic data set to determine the at least part of the structure at a later date, or “off line”.

The at least one wideband acoustic signal transmission and reception device may be operable to modifying the at least one wideband acoustic signal transmitted therefrom in dependence on the results obtained from the analysis of the at least one, or each, acoustic data set. In this arrangement the at least one, or each, wideband acoustic signal may be intelligently adapted to optimise the method of determining the at least part of the structure of the object.

The apparatus may further comprise a location, or geolocation, determination module to determine the location, or geolocation of the at least part of the structure of the object.

The apparatus may be operable to determine substantially the entire structure of the object.

The apparatus may further comprise an object identification module operable to identifying the object. The identification of the object may be determined by determining a plurality of parts of the structure of the object.

The apparatus may further comprise an object classification module operable to classify the object. The classification of the object may be determined by determining a plurality of parts of the structure of the object.

The apparatus may further comprise an object assessment module operable to assess the condition of the object. The assessment of the condition of the object may comprise determining a plurality of parts of the structure of the object, and optionally comparing this with predetermined, or known, data on the part of the structure.

Where the object has a number of parts, or components, the apparatus may be operable to determine at least a part of the structure of each part, or component, of the object.

Where the object contains, or is filled with, a solid, liquid or gas, the apparatus is operable to determine at least a part of the structure of the object and the material contained therein.

The apparatus may further a plurality of wideband acoustic signal transmission and reception devices, each wideband acoustic signal transmission and reception device being capable of transmitting and receiving one or more wideband acoustic signals.

According to a third aspect of the present invention there is provided a method of determining at least one physical property of an object, the method comprising the steps of:
providing at least one wideband acoustic signal transmission and reception device, the at least one wideband acoustic signal transmission and reception device being capable of transmitting and receiving one or more wideband acoustic signals;
using the at least one wideband acoustic signal transmission and reception device to transmit at least one wideband acoustic signal towards at least a portion of the object;
using the at least one wideband acoustic signal transmission and reception device to receive at least one wideband acoustic signal from the object;
using the received at least one wideband acoustic signal from the object to create at least one acoustic data set; and
analysing the at least one acoustic data set to determine the at least one physical property of the object.

Embodiments of the third aspect of the invention may include one or more features of the first aspect of the invention or its embodiments. Similarly, embodiments of the first aspect of the invention may include one or more features of the third aspect of the invention or its embodiments.

According to a fourth aspect of the present invention there is provided a method of determining at least one geometric property of an object, the method comprising the steps of:
providing at least one wideband acoustic signal transmission and reception device, the at least one wideband acoustic signal transmission and reception device being capable of transmitting and receiving one or more wideband acoustic signals;
using the at least one wideband acoustic signal transmission and reception device to transmit at least one wideband acoustic signal towards at least a portion of the object;
using the at least one wideband acoustic signal transmission and reception device to receive at least one wideband acoustic signal from the object;
using the received at least one wideband acoustic signal from the object to create at least one acoustic data set; and
analysing the at least one acoustic data set to determine the at least one geometric property of the object.

Embodiments of the fourth aspect of the invention may include one or more features of the first aspect of the invention or its embodiments. Similarly, embodiments of the first aspect of the invention may include one or more features of the fourth aspect of the invention or its embodiments.

According to a fifth aspect of the invention there is provided a wideband acoustic signal transmission and reception device comprising:
at least one transducer element having a plurality of array elements, wherein each array element is configurable to transmit or receive at least one wideband acoustic signal; and
at least one filtering module, the at least one filtering module being operable with at least one array element to filter a transmitted wideband acoustic signal therefrom or a received wideband acoustic signal thereto.

The at least one transducer element may be a piezoelectric transducer element.

The array elements may be piezoelectric elements. The array elements may be piezoelectric columns.

The plurality of array elements may be arranged in a circular arrangement.

The plurality of array elements may be arranged in a concentric ring circular arrangement.

The plurality of array elements may be arranged in a rectangular arrangement.

The plurality of array elements may be arranged in an octagonal or other geometric arrangement.

The at least one filtering module may be operable with each array element of the transducer element.

The at least one filtering module may be selectively operable with one or more array elements of the transducer element.

The at least one filtering module may include one or more frequency-dependent filters.

The frequency-dependent filters may include discrete electrical components.

The frequency-dependent filters may include digital filters.

The one or more frequency dependent filters may be phase preservation filters.

The one or more frequency-dependent filters may be low-pass filters.

Where the frequency-dependent filters are discrete electrical components, the at least one filtering module may assign a specific frequency-dependent filter to each array element. Each array element may include a specific, or unique, frequency-dependent filter.

The at least one transducer element may be arranged such that the array elements include a central portion of array elements and a peripheral portion of array elements. The central portion of the array element may be circular-shaped and the peripheral portion of array elements may be ring-shaped. In this arrangement the peripheral portion and the central portion are concentric. The at least one transducer element may include a plurality of concentric ring-shaped peripheral portions, each portion being concentric with the central portion.

The plurality of array elements may be arranged in a concentric ring circular arrangement.

The at least one transducer element may be arranged such that the band-pass of the low-pass filters assigned to the array elements at a central portion of the array is greater than the band-pass of the low-pass filters assigned to the array elements at a peripheral portion of the array. In this arrangement the band-pass of the low-pass filters assigned to each array element progressively decreases between array elements located at the central portion of the array and array elements located at the peripheral portion of the array.

Where the frequency-dependent filters include digital filters, the at least one filtering module is operable to filter transmitted and/or received wideband acoustic signals from groups of array elements that are equidistant from a centre of the array. Where the frequency-dependent filters include digital filters, the at least one filtering module is operable to filter transmitted and/or received wideband acoustic signals from one or more selected array elements within the array. The one or more selected array elements may include any array element, or elements, within the array. In this arrangement the wideband acoustic signal transmission and reception device includes a computer, wherein the computer includes software capable of operating the filtering module to filter the transmitted and received wideband signals with the digital filters and to sample and record digital data therefrom. The sampled and recorded digital data may form part of the at least one acoustic data set.

The received signal from each array element may be recorded and stored independently.

Array elements grouped together according to some geometrical arrangement may be termed sub-arrays

Sub-arrays may be groups of array elements that are equidistant from a centre of the array.

The groups of array elements that are equidistant from a centre of the array may be termed sub-arrays.

The at least one filtering module may include one or more time-varying filters, or range-dependent filters.

The time-varying filters, or range-dependent filters, may include discrete electrical components.

The time-varying filters, or range-dependent filters, may include digital filters.

The one or more time-varying filters, or range-dependent filters, may be phase preservation filters.

Where the time-varying filters, or range-dependent filters are discrete electrical components, the at least one filtering module may assign a specific time-varying filter, or range-dependent filter, to each array element. Each array element may include a specific, or unique, time-varying filter, or range-dependent filter.

Where the time-varying filters, or range-dependent filters, include digital filters, the at least one filtering module is operable to filter transmitted and/or received wideband acoustic signals from groups of array elements that are equidistant from a centre of the array. Where the time-varying filters, or range-dependent filters, include digital filters, the at least one filtering module is operable to filter transmitted and/or received wideband acoustic signals from one or more selected array elements within the array. The one or more selected array elements may include any array element, or elements, within the array. In this arrangement the wideband acoustic signal transmission and reception device includes a computer, wherein the computer includes software capable of operating the filtering module to filter the transmitted and received wideband signals with the digital filters and to sample and record digital data therefrom. The sampled and recorded digital data may form part of the at least one acoustic data set.

Array elements grouped together according to some geometrical arrangement may be termed sub-arrays

Sub-arrays may be groups of array elements that are equidistant from a centre of the array.

The received signal from each array element may be recorded and stored independently.

The wideband acoustic signal transmission and reception device may include a system control unit, which includes a central processing unit (CPU). The system control unit may be configured to control the operation of the at least one transducer element and the at least one filtering module.

The system control unit may be operable to control the transmission and reception of each array element, or groups of array elements, of the at least one transducer element.

The wideband acoustic signal transmission and reception device may comprise two or more transducer elements, wherein each transducer element has a plurality of array elements, wherein each array element is configurable to transmit or receive at least one wideband acoustic signal.

The wideband acoustic signal transmission and reception device may comprise two or more filtering modules, wherein each filtering module is operable with at least one array element to filter a transmitted wideband acoustic signal therefrom or a received wideband acoustic signal thereto. The at least one transducer element may have a quality factor (Q factor) of less than 5.0. The at least one wideband acoustic signal transmission and reception device may have a Q factor of less than 2.0. The at least one wideband acoustic signal transmission and reception device may have a Q factor of less than 1.0.

The at least one transducer element may be capable of transmitting and receiving wideband acoustic signals at more than 1 octave. The at least one transducer element may be capable of transmitting and receiving wideband acoustic signals at more than 2 octaves. The at least one transducer element may be capable of transmitting and receiving wideband acoustic signals at more than 3 octaves.

The at least one transducer element may have a high transmission and reception sensitivity. The at least one transducer element may have a reception sensitivity that allows reception of acoustic signals of between 3 dB and 30 dB below the primary echo level for the object of interest. The at least one transducer element may therefore be capable of receiving wideband acoustic signals at dynamic ranges up to 96 dB for 16-bit systems and up to 144 dB for 24-bit systems and up to 192 dB for 32-bit systems. The efficiency of the at least one transducer element may be greater than 50%. The efficiency of the at least one transducer element may be greater than 65%.

The transmitted at least one wideband acoustic signal may have a frequency range between approximately 1 kHz and 2.5 MHz. The transmitted at least one wideband acoustic signal may have a frequency range between approximately 1 kHz and 1 MHz. The transmitted at least one wideband acoustic signal may have a frequency range between approximately 1 kHz and 300 kHz. The transmitted at least one wideband acoustic signal may have a frequency range between approximately 1 kHz and 200 kHz. The transmitted at least one wideband acoustic signal may have a frequency range between approximately 5 kHz and 200 kHz. The transmitted at least one wideband acoustic signal may have a frequency range between approximately 25 kHz and 1 MHz. The transmitted at least one wideband acoustic signal may have a frequency range between approximately 30 kHz and 150 kHz. The transmitted at least one wideband acoustic signal may have a frequency range between approximately 10 kHz and 200 kHz. The transmitted at least one wideband acoustic signal may have a frequency range between approximately 5 kHz and 100 kHz.

The transmitted at least one wideband acoustic signal may have a beam angle, or beam width, of between approximately 10 degrees to 120 degrees. The transmitted at least one wideband acoustic signal may have a beam angle of approximately 10 degrees, 20 degrees, 30 degrees, 40 degrees, 50 degrees, 60 degrees, 70 degrees, 80 degrees, 90 degrees, 100 degrees, 110 degrees and 120 degrees. The transmitted at least one wideband acoustic signal may have a beam angle, or beam width, of between approximately 1 degrees to 120 degrees.

The transmitted at least one wideband acoustic signal may have a wave number k, where k=2π/λ, or k=2πf/c, and where λ is the wavelength of the acoustic signal in the material in which the acoustic signal is travelling, c is the speed of the acoustic signal in the material in which the acoustic signal is travelling, and f is the frequency of the acoustic signal in the material in which the acoustic signal is travelling, and the transmitted at least one wideband acoustic signal may be transmitted in the range of k.a of between 5 and 100 ([5:100]), where a is a dimension of the object, such as radius, diameter, length, wall thickness, or the like. The k.a range may alternatively be between 10 and 60 ([10:60]). The k.a range may alternatively be between approximately 1 and approximately 100 ([1:100]).

The at least one wideband acoustic signal may include at least one frequency chirp. The frequency chirp may be an up-chirp, where the frequency increases. Alternatively, the frequency may be a down-chirp, where the frequency decreases. The at least one wideband acoustic signal may include a first chirp having a first frequency range and a second chirp having a second frequency range. The first frequency range may be different from the second frequency range. The first frequency range may be higher or lower than the second frequency range.

The frequency chirp may be a linear chirp, where the frequency changes linearly. The frequency chip may be a non-linear chirp, where the frequency changes non-linearly. The frequency chip may be an exponential chirp, where the frequency changes exponentially.

The first frequency chirp and the second frequency chirp may overlap in time. The first frequency chirp and the second frequency chirp may overlap in time for more than 50% of the duration of the first chirp. The first frequency chirp and the second frequency chirp may overlap in time for more than 70% of the duration of the first chirp. The first frequency chirp and the second frequency chirp may overlap in time for more than 80% of the duration of the first chirp. The first frequency chirp and the second frequency chirp may overlap in time for more than 90% of the duration of the first chirp.

The at least one wideband acoustic signal may include a plurality of frequency chirps. The at least one wideband acoustic signal may include an up-chirp and a down-chirp. The at least one wideband acoustic signal may include two or more stacked frequency chirps. The at least one wideband acoustic signal may include a plurality of stacked frequency chirps. The at least one wideband acoustic signal may include a plurality of stacked up-chirps and/or stacked down-chirps.

The at least one wideband acoustic signal transmission and reception device may include a combined transmission and reception wideband acoustic signal transducer. In this arrangement the at least one wideband acoustic signal is transmitted and received from a single transducer.

The at least one wideband acoustic signal transmission and reception device may include a transmission wideband acoustic signal transducer and a reception wideband acoustic signal transducer. In this arrangement the at least one wideband acoustic signal is transmitted from a first transducer and the at least one wideband acoustic signal from the object is received at a second transducer.

Embodiments of the fifth aspect of the invention may include one or more features of the first aspect of the invention or its embodiments. Similarly, embodiments of the first aspect of the invention may include one or more features of the fifth aspect of the invention or its embodiments.

According to a sixth aspect of the invention there is provided a method of determining at least part of the structure of an object, the method comprising the steps of:
providing at least one wideband acoustic signal transmission and reception device according to the fifth aspect of the invention;
using the at least one wideband acoustic signal transmission and reception device to transmit at least one wideband acoustic signal towards at least a portion of the object;
using the at least one wideband acoustic signal transmission and reception device to receive at least one wideband acoustic signal from the object;
using the received at least one wideband acoustic signal from the object to create at least one acoustic data set; and
analysing the at least one acoustic data set to determine the at least part of the structure of the object.

Embodiments of the sixth aspect of the invention may include one or more features of the first aspect of the invention or its embodiments. Similarly, embodiments of the first aspect of the invention may include one or more features of the sixth aspect of the invention or its embodiments.

The alternative features and different embodiments as described apply to each and every aspect and each and every embodiment thereof mutatis mutandis.

Embodiments of the invention will now be described, by way of example only, with reference to the accompanying drawings, in which:—

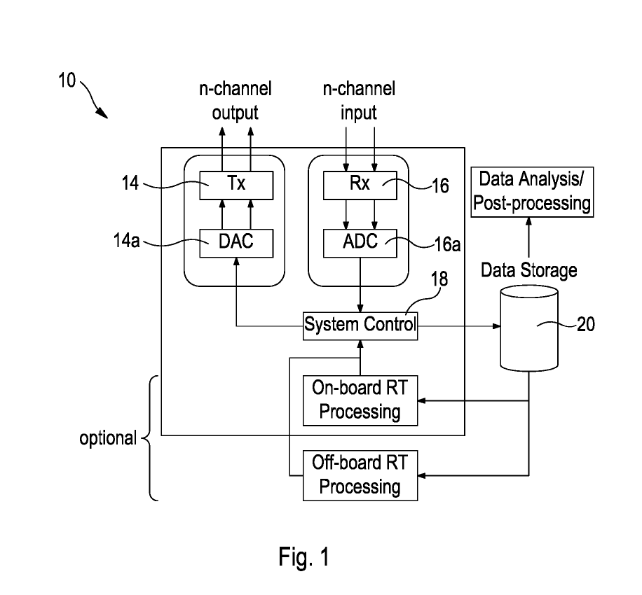

FIG. 1 is a schematic representation of an apparatus for determining at least part of the structure of an object;

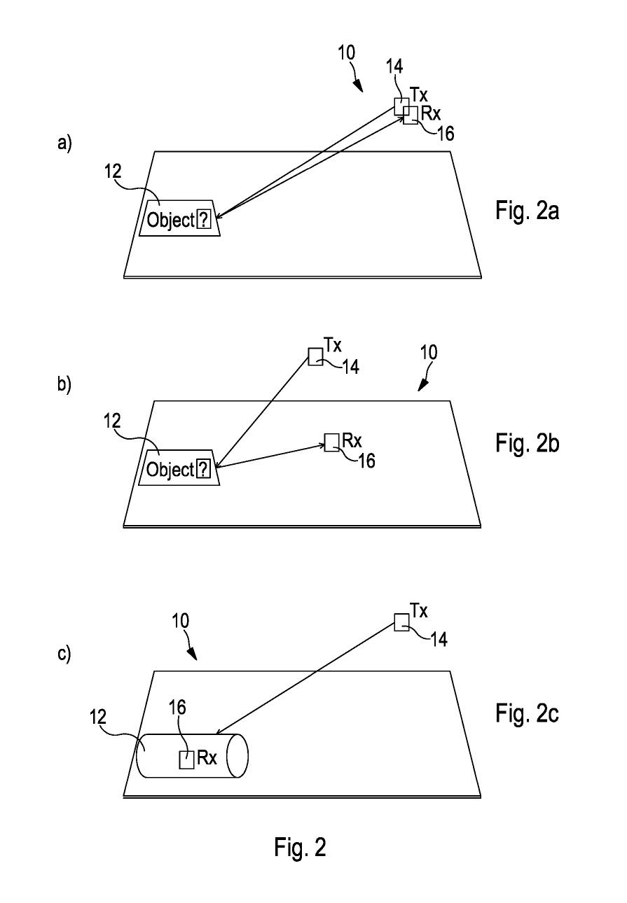

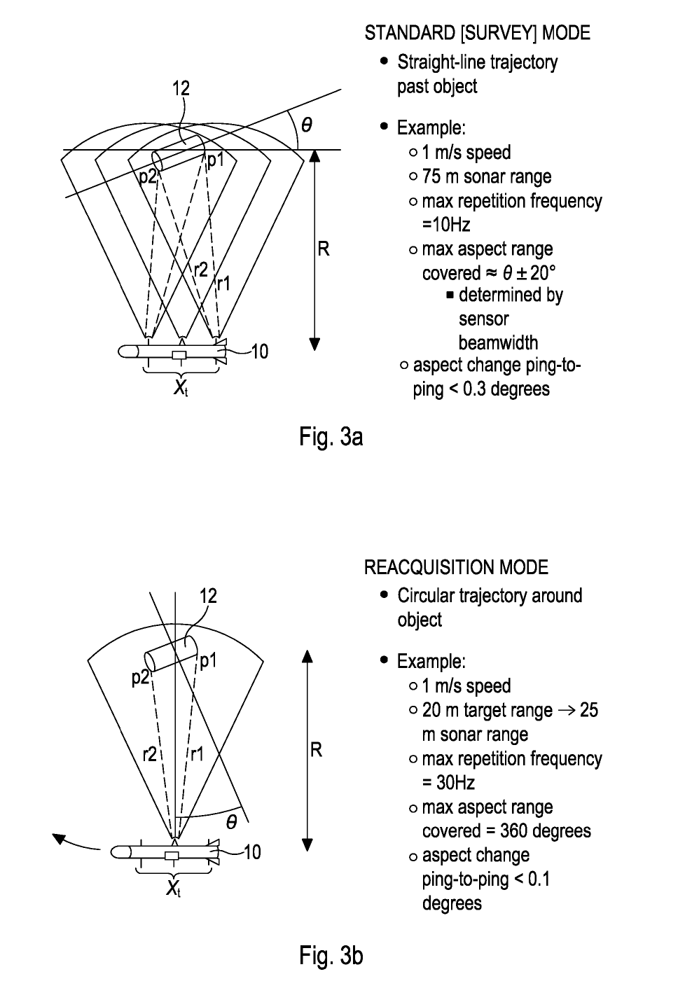

FIGS. 2a to 2c, 3a and 3b are schematic representations of the apparatus of FIG. 1 in use;

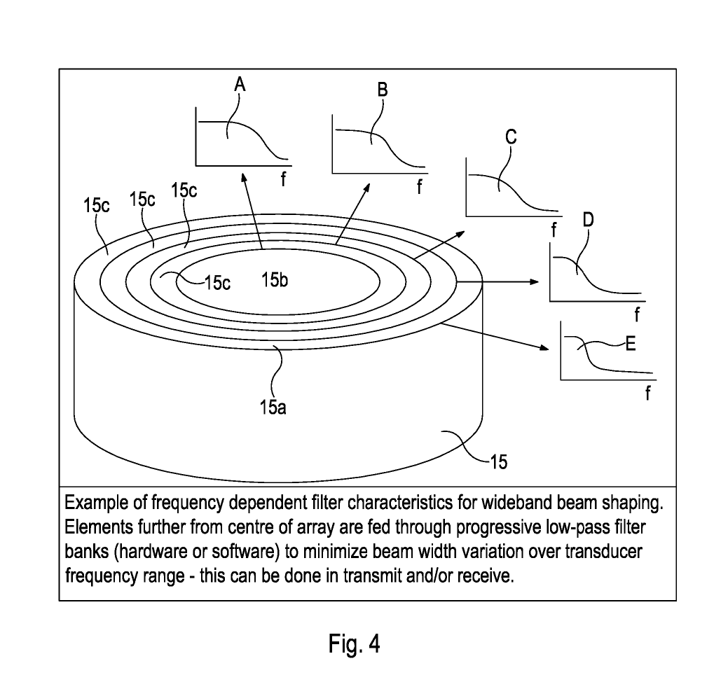

FIG. 4 is a schematic side view of part of a transducer element of a wideband acoustic signal transmission and reception device; and

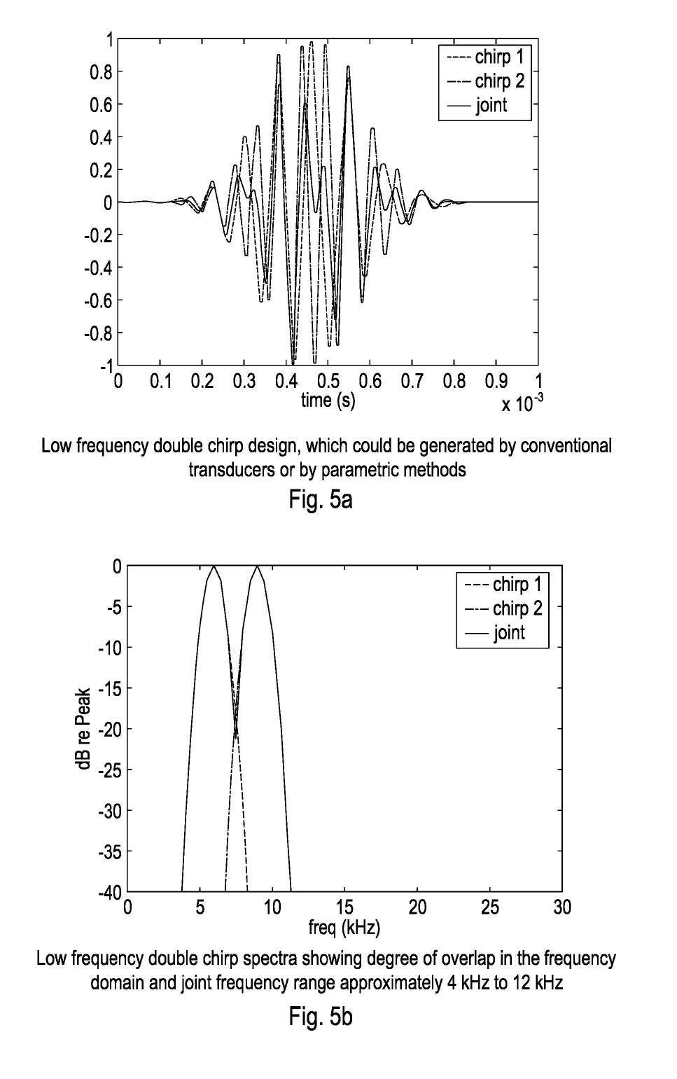

FIGS. 5a and 5b are examples of acoustic signals that may be used in the present invention.

FIGS. 1 and 2 illustrate an apparatus 10 for determining at least part of the structure of an object 12. The apparatus 10 is a wideband sonar (WBS) system, which uses patterns of resonance to detect, classify, recognize and identify underwater objects and to identify differences, or changes, in condition, content or structure. With reference to FIG. 2, the apparatus 10 and the object 12 are separated by a volume of water (not illustrated). The apparatus 10 is therefore a “non-contact” apparatus. The apparatus 10 is capable of insonifying the entire object 12, or a portion of the object 12, depending on how the wideband acoustic signals are transmitted.

In the context of the present application, the term “structure” is considered to include any one or more of the following features of the object 12: its shape, dimension(s), size, thickness, composition, physical state (e.g. solid, liquid, gas, plasma), material of construction, physical properties (e.g. absorption (physical), absorption (electromagnetic), density, dielectric polarisability/permittivity, hardness, mass, sound speed in object (longitudinal for sound speed for fluid, gas and solid and transversal sound speed for solid only), content, surface roughness, topographical information, layering, heterogeneity, reflectivity and granularity.

Where the object 12 comprises of a number of different components or materials, or where the object 12 contains another object, such as a solid, liquid or gas, the term “structure” is considered to include any one or more of the following features of the object 12: its shape, the shape of each component, the dimensions of each component, the size of each component, the thickness of each component, the composition of each component, the physical state (e.g. solid, liquid, gas, plasma) of each component, the material of construction of each component, the physical properties (e.g. absorption (physical) of each component, the absorption (electromagnetic) of each component, the density of each component, the dielectric polarisability/permittivity of each component, the hardness of each component, the mass of each component, the sound speed in each object (longitudinal for sound speed for fluid, gas and solid and transversal sound speed for solid only), the content of each object, the surface roughness of each component, topographical information of each component, the arrangement of each component with respect to one another, the layering of each object, the heterogeneity of each object, the reflectivity of each object and the granularity of each object.

The apparatus 10 includes a wideband acoustic transmitter 14 and a wideband acoustic receiver 16. Wideband acoustic transmitter 14 and wideband acoustic receiver 16 are an example of at least one wideband acoustic signal transmission and reception device.

The wideband acoustic transmitter 14 includes a transducer element 15, as illustrated in FIG. 4. The transducer element 15 may be a single-array transducer. Alternatively, the transducer element 15 may be a multi-array transducer. In either case, the transducer element 15 is capable of transmitting a plurality of wideband acoustic signals.

In the embodiment illustrated and described in FIG. 4, the transducer element 15 comprises a number of array elements 15a. The array elements 15a are piezoelectric transducer elements which are arranged in a concentric ring circular arrangement. The array incudes a centre portion 15b and concentric ring portions 15c.

The wideband acoustic transmitter 14 (transducer element 15) has a quality factor (Q factor) of less than 2. However, it should be appreciated that the Q factor of the wideband acoustic transmitter 14 may be between 1 and 2, or between 2 and 5. The wideband acoustic transmitter 14 is capable of transmitting wideband acoustic signals at more than 1 octave. The wideband acoustic transmitter 14 may also be capable of transmitting wideband acoustic signals at more than 2 octaves. The wideband acoustic transmitter 14 may also be capable of transmitting wideband acoustic signals at more than 3 octaves. The wideband acoustic transmitter 14 has a high transmission sensitivity. The efficiency of the wideband acoustic transmitter 14 is greater than 50%, and may be greater than 65%. The wideband acoustic transmitter 14 is capable of transmitting acoustic signals in the frequency range between approximately 1 kHz to 2.5 MHz. It should be appreciated that the wideband acoustic transmitter 14 is capable of transmitting acoustic signals at any frequency between this range, or acoustic signals at a sub-range of frequencies within this range. The wideband acoustic transmitter 14 is capable of transmitting acoustic signals at any beam width between approximately 1 to 120 degrees. It should be appreciated that the wideband acoustic transmitter 14 is capable of transmitting acoustic signals at any beam width between this range, or acoustic signals at a sub-range of beam widths within this range.

The transmitted wideband acoustic signal may have a wave number k, where k=2π/λ, or k=2πrf/c, and where λ is the wavelength of the acoustic signal in the material in which the acoustic signal is travelling, c is the speed of the acoustic signal in the material in which the acoustic signal is travelling, and f is the frequency of the acoustic signal in the material in which the acoustic signal is travelling, and the transmitted at least one wideband acoustic signal may be transmitted in the range of k.a of between 1 and 100 ([1:100]), where a is a dimension of the object, such as radius, diameter, length, wall thickness, or the like. The k.a range may alternatively be between 5 and 100 ([5:100]), or 10 and 60 ([10:60]). It should however be appreciated that the transmitted acoustic signal from the wideband acoustic transmitter 14 may also be in one or more sub-ranges of those described above.

The wideband acoustic receiver 16 includes a transducer element (not illustrated). The transducer element may be identical, or substantially identical, to the transducer element 15. The transducer element may be a single-array transducer. Alternatively, the transducer element may be a multi-array transducer element. In either case, the transducer element is capable of receiving a plurality of wideband acoustic signals (reflected from the object 12).

The wideband acoustic receiver 16 (transducer element) has a quality factor (Q factor) of less than 2. However, it should be appreciated that the Q factor of the wideband acoustic receiver 16 may be between 1 and 2, or between 2 and 5. The wideband acoustic receiver 16 is capable of receiving wideband acoustic signals at more than 1 octave. The wideband acoustic receiver 16 may also be capable of receiving wideband acoustic signals at more than 2 octaves. The wideband acoustic receiver 16 may also be capable of receiving wideband acoustic signals at more than 3 octaves. The wideband acoustic receiver 16 has a high reception sensitivity. The efficiency of the wideband acoustic receiver 16 is greater than 50%, and may be greater than 65%. The wideband acoustic receiver 16 is capable of receiving acoustic signals that are between approximately 3 dB and 30 dB below the transmitted acoustic signal from the wideband acoustic transmitter 14. The at least one wideband acoustic signal transmission and reception device has a high transmission and reception sensitivity. The at least one wideband acoustic signal transmission and reception device should be below the primary echo level for the object of interest. The efficiency of the at least one wideband acoustic signal transmission and reception device may be greater than 50%. The efficiency of the at least one wideband acoustic signal transmission and reception device may be greater than 65%.

This ensures that multiple low-level secondary echoes can be integrated into the signal analysis, as described below. The wideband acoustic receiver 16 is capable of receiving acoustic signals in the frequency range between approximately 1 kHz to 2.5 MHz. It should be appreciated that the wideband acoustic receiver 16 is capable of receiving acoustic signals at any frequency between this range, or acoustic signals at a sub-range of frequencies within this range.

The wideband acoustic transmitter 14 includes a digital-to-analogue converter (DAC) 14a, and the wideband acoustic receiver 16 includes an analogue-to-digital converter (ADC) 16a.

The apparatus 10 also includes a system control unit 18, which includes a central processing unit (CPU) (not illustrated), a power amplification unit (not illustrated), and very low noise amplifiers (not illustrated). The system control unit 18 also includes electrical matching circuitry and a transmitter interface (not illustrated) for the wideband acoustic transmitter 14, and electrical matching circuitry and a receiver interface (not illustrated) for the wideband acoustic receiver 16.

The apparatus 10 also includes a filtering module (not illustrated). The filtering module may be controlled by the system control unit 18. The filtering module is operable with the array elements 15a to filter the transmitted wideband acoustic signal transmitted from the transmitter 14 (transducer element 15) or to filter a received wideband acoustic signal received by the receiver 16 (transducer element).

The filtering module includes frequency-dependent filters and time-varying filters, or range-dependent filters (not illustrated). The filters may be implemented in hardware (i.e. filters made from discrete electrical components), or through software (i.e. digital filters). The system control unit 18 may be operable to control the digital filters. The filters are phase preservation filters. The frequency-dependent filters are low-pass filters.

The filtering module assigns a specific filter element (frequency-dependent filter, time-varying filter, or range-dependent filter) to each array element 15a. Each filter element, or groups of filter elements, may have different characteristics, or properties, in terms of their frequency filtering characteristics, and range varying characteristics.

An example of the different characteristics of the frequency band-pass variation is illustrated in FIG. 4. The transducer element 15 is arranged such that the band-pass of the low-pass filters assigned to the array elements 15a at a central portion 15b of the array is greater than the band-pass of the low-pass filters assigned to the array elements at a peripheral portions 15c of the array. As illustrated in FIG. 4, in this arrangement the band-pass of the low-pass filters assigned to each array element 15a progressively decreases between array elements located at the central portion 15b of the array and array elements located at the peripheral portion 15c of the array. The band-pass (or corner frequency) shifts progressively downwards for array elements closer to the periphery of the array, as illustrated in graphs A, B, C, D and E in FIG. 4. In this way fewer array elements contribute to beam shaping at higher frequencies, thus opening out the high frequency beam width. The array is designed for a target beam width defined for the low frequency end of the frequency range. The filters are designed to progressively widen the beam width at higher frequencies to match the design beam width for the lowest frequencies. Phase preservation is required of the filters used for this application.

Where the frequency-dependent filters include digital filters, the filtering module is operable to filter transmitted and/or received wideband acoustic signals from groups of array elements that are equidistant from a centre of the array. Alternatively, the filtering module is operable to filter transmitted and/or received wideband acoustic signals from one or more selected array elements within the array. The one or more selected array elements may include any array element, or elements, within the array. In this arrangement the wideband acoustic signal transmission and reception device includes a computer, wherein the computer includes software capable of operating the filtering module to filter the transmitted and received wideband signals with the digital filters and to sample and record digital data therefrom. The sampled and recorded digital data may form part of the at least one acoustic data set.

The wideband acoustic transmitter 14 and wideband acoustic receiver 16 are jointly used for both sonar imaging and for wideband analysis in signal processing. This has advantages in guaranteeing information from the same object, or aspect, in two different sensing modalities will provide an enhanced capability. The wideband acoustic transmitter 14 and wideband acoustic receiver 16 may also be jointly used with very wideband low-frequency parametric acoustic techniques, i.e. a very wideband low-frequency parametric array of elements.

The frequency-dependent filtering and/or range-dependent filtering of individual array elements in hardware, or software, provide frequency-dependent and/or range-dependent beam shaping, or profiling. This can, for example, allow insonificaiton of a fixed size patch, or area, of a target object, such as the seabed, at all ranges and/or fixed beam width over the whole frequency band.

The response from each array element of the receiver 16 may be recorded independently, allowing for custom beam forming. Alternatively, the response from each array element may be directly filtered independently for custom beam forming.

The beam may be formed to achieve a beam width which is the same at all frequencies within the frequency band. In another version the beam may be formed to achieve a beam which is range dependent so that the size of the insonified patch, or area, can be controlled with range. In one arrangement the insonified area, or patch, may be of fixed size with range. Alternatively, the beam forming may be arranged to focus on the object of interest with the two constraints: the beam has to be wide enough to insonify the full object or at least its important parts, the beam has to be as narrow as possible to reduce the reverberation level. Beam control may then be driven by environment/seabed type as well as object dimensions.

The system control unit 18 also includes firmware and software that controls the operation of the wideband acoustic transmitter 14 and wideband acoustic receiver 16. These include, inter alia, acoustic signal shaping (pulse shaping), signal conditioning and filtering, signal processing, controlling data rates, pulse timings, range settings gain settings, data storage, data management and data logging.

The system control unit 18 may be an example of an acoustic data set module and an acoustic data set analysis module. As illustrated in FIG. 1, the analysis of the acoustic data set to determine the at least part of the structure may be carried out in real-time on the apparatus 10 (“on-board”), or may be carried out at a later date, or “off line” (“off-board”). In this arrangement the data may be stored on an external data storage device 20.

The wideband acoustic signal transmitted by the wideband acoustic transmitter 14 may include a frequency chirp. The frequency chirp may be an up-chirp, where the frequency increases. Alternatively, the frequency may be a down-chirp, where the frequency decreases. The wideband acoustic signal may include a first chirp having a first frequency range and a second chirp having a second frequency range. The first frequency range may be different from the second frequency range. The first frequency range may be higher or lower than the second frequency range.

The frequency chirp may be a linear chirp, where the frequency changes linearly. The frequency chip may be a non-linear chirp, where the frequency changes non-linearly. The frequency chip may be an exponential chirp, where the frequency changes exponentially.

The first frequency chirp and the second frequency chirp may overlap in time. The first frequency chirp and the second frequency chirp may overlap in time for more than 50% of the duration of the first chirp. The first frequency chirp and the second frequency chirp may overlap in time for more than 70% of the duration of the first chirp. The first frequency chirp and the second frequency chirp may overlap in time for more than 80% of the duration of the first chirp. The first frequency chirp and the second frequency chirp may overlap in time for more than 90% of the duration of the first chirp.

The wideband acoustic signal may include a plurality of frequency chirps. The wideband acoustic signal may include an up-chirp and a down-chirp. The wideband acoustic signal may include two or more stacked frequency chirps. The wideband acoustic signal may include a plurality of stacked frequency chirps. The wideband acoustic signal may include a plurality of stacked up-chirps and/or stacked down-chirps.

FIG. 5a illustrates a low frequency double chirp, which may be generated by conventional transducers, or by parametric methods.

FIG. 5b illustrates a low frequency double chirp spectra with a degree of overlap in the frequency domain and joint frequency range of approximately 4 kHz to 12 kHz.

The delays between chirps in a multi-chirp pulse can be matched to the spacing between principal target/object scatterers. This allows: fine measurement between target/object scatterers (to a precision within 1/10^{th} of the wavelength (c/f, where c is the speed of the acoustic signal in the material in which the acoustic signal is travelling, and f is the frequency of the acoustic signal in the material in which the acoustic signal is travelling); maximising the echo strength by constructive interferences; and maximising the discrimination between this and other targets/objects (other targets with different spacing between scatterers will cause destructive interferences).

As illustrated in FIG. 2a, the wideband acoustic transmitter 14 and wideband acoustic receiver 16 may be located together. This arrangement may be termed “monostatic in water column outside object of interest”. The monostatic configuration may be used in a fixed platform (not illustrated), in a moving platform (not illustrated), such as an autonomous underwater vehicle (AUV), remotely operated vehicle (ROV), tow fish, tow bar, or a diver operated device. The monostatic system includes a number of possible modes, giving different look angles and target aspects, for example, sidescan configuration, forward-looking configuration and gap-filler configuration.

As illustrated in FIG. 2b, the wideband acoustic transmitter 14 and wideband acoustic receiver 16 may be separated from one another. This arrangement may be termed “bistatic in water column outside object of interest”. As illustrated in FIG. 2c, the wideband acoustic receiver 16 may be located with, or within, the object 12. This arrangement may be termed “bistatic, source outside object of interest, receiver inside object of interest”.

Although not illustrated, it should be appreciated that the apparatus 10 may include a plurality of wideband acoustic transmitters 14 and wideband acoustic receivers 16. This may be termed “multi static sonar—multiple transmitters and multiple receivers are present in the environment”. Multiple transmitters present in the environment may include transmitter location selection based on optimising coverage, increasing diversity of views and view independence optimisation. Multi static systems may need independent views for object diversity or correlated views for tracking and denoising. Multiple transmitters 14 also permits orthogonal pulse design. Multiple receivers 16 allows transmitter pulse separation, pulse fusions, echo integration, sub-synthetic aperture algorithms for echo reconstruction, acoustical tomography and multiple input multiple output (MIMO) detection/recognition algorithms.

Although not illustrated, it should be appreciated that the wideband acoustic transmitter 14 (an example of a first transducer) and wideband acoustic receiver 16 (an example of a second transducer) may be located within the object 12. In this case, the apparatus 10 may be used for structural assessment of the object, flaw detection of the object, detection of wall thinning of the object, deposition of materials within the object and flood detection within the object.

As explained further below, the wideband acoustic transmitter 14 may be configurable to selectively optimise the k.a range of the wideband acoustic signal in dependence on one or more predetermined, or known, features of the object, or the environment in which the object is located. The wideband acoustic transmitter 14 may also be configurable to vary any one, or all, of the frequency, amplitude, transmission time and beam angle, or beam width, of the wideband acoustic signal. The wideband acoustic transmitter 14 may also be configurable to vary any one, or all, of the frequency, amplitude, transmission time and beam angle, or beam width, of the wideband acoustic signal during transmission and/or reception of the wideband acoustic signal. In this arrangement the wideband acoustic signal may be variable, or continuously variable, in terms of its frequency, amplitude, transmission time and beam angle, or beam width. The wideband acoustic transmitter 14 may also be configurable to optimise any one, or all, of the frequency, amplitude, transmission time and beam angle, or beam width, of the wideband acoustic signal in dependence one or more predetermined, or known, features of the object, or the environment in which the object is located. The wideband acoustic transmitter 14 may also be configurable to focus acoustic signal energy onto selected regions of the spectra. The wideband acoustic transmitter 14 may also be configurable to concentrate energy in part of the frequency containing maximum information for an object/environment and/or to minimise the impact of the environment which includes other objects. This maximises backscattering echo; maximises the target/object resonances; and maximises the discrimination between this and other targets/objects.

In use, the apparatus 10 may be used to insonify the object 12 (or at least a portion thereof). The apparatus 10 may also be used to insonify the object 12 and a portion of the surrounding environment. Alternatively, the apparatus 10 may be used to insonify the environment on its own, such as the seabed.

As described above, and illustrated in FIGS. 2, 3a and 3b, the apparatus 10 and the object 12 are separated by a volume of water (not illustrated). The apparatus 10 is therefore a “non-contact” apparatus.

The wideband acoustic transmitter 14 of the apparatus 10 is used to transmit one or more wideband acoustic signals to the object. As described above, the wideband acoustic transmitter 14 has a quality factor (Q factor) of less than 2. The signals may be transmitted at more than 1 octave. It should be appreciated that the signals may be transmitted at more than 2 octaves, or 3 octaves. The wideband acoustic signals transmitted by the wideband acoustic transmitter 14 may be between approximately 1 kHz to 2.5 MHz. As described above, the wideband acoustic transmitter 14 is capable of transmitting acoustic signals at any frequency between this range, or acoustic signals at a sub-range of frequencies within this range. The wideband acoustic signal may have a beam width between approximately 1 to 120 degrees. As described above, the wideband acoustic transmitter 14 is capable of transmitting acoustic signals at any beam width between this range, or acoustic signals at a sub-range of beam widths within this range.

As illustrated in FIG. 3a, the apparatus 10 may be operated in “standard survey mode”, where the apparatus 10 passes on a straight-line trajectory past the object 12. As illustrated, the apparatus 10 transmits a plurality of wideband acoustic signals towards the object 12 as it passes thereby. In the embodiment illustrated and described here, the apparatus 10 is travelling at approximately 1 m/s and is at a distance of 75 m from the object 12. The maximum repetition frequency in this case is 10 Hz. The maximum aspect range covered is approximately ±20 degrees (this is determined by the sensor beam width. The aspect change from signal-to-signal is less than 0.3 degrees. However, it should be appreciated that the above-described parameters may be varied depending on the requirements of the apparatus 10.

As illustrated in FIG. 3a, the apparatus 10 may be operated in “reacquisition mode”, where the object is insonified for a second time. In this operation the apparatus 10 may have a circular trajectory about the object 12. In the embodiment illustrated and described here, the apparatus 10 is travelling at approximately 1 m/s and is at a distance of 20 to 25 m from the object 12. The maximum repetition frequency in this case is 30 Hz. The maximum aspect range covered is 360 degrees. The aspect change from signal-to-signal is less than 0.1 degrees. However, it should be appreciated that the above-described parameters may be varied depending on the requirements of the apparatus 10.

As described above, the transmitted wideband acoustic signal may be transmitted in the range of k.a of between 1 and 100 ([1:100]). The k.a range may alternatively be between 5 and 100 ([5:100]), or 10 and 60 ([10:60]). It should however be appreciated that the transmitted acoustic signal from the wideband acoustic transmitter 14 may also be in one or more sub-ranges of those described above. The transmitted wideband acoustic signal may also be selected to optimise the k.a range of the wideband acoustic signal in dependence on one or more predetermined, or known, features of the object, or the environment in which the object is located. The wideband acoustic signal may also be configurable to vary any one, or all, of the frequency, amplitude, transmission time and beam angle (beam width) of the wideband acoustic signal. The wideband acoustic signal may also be configurable to vary any one, or all, of the frequency, amplitude, transmission time and beam angle, or beam width, of the wideband acoustic signal during transmission and/or reception of the wideband acoustic signal. In this arrangement the wideband acoustic signal may be variable, or continuously variable, in terms of its frequency, amplitude, transmission time and beam angle, or beam width.

The transmitted wideband acoustic signal may be transmitted repeatedly. The repetition rate of the transmission of wideband acoustic signals may be variable. The repetition rate of the transmission of wideband acoustic signals is directly proportional to the distance between the at least one wideband acoustic signal transmission and reception device and the object.

The transmitted acoustic signals may be adjusted to match the repetition rate of the transmission of wideband acoustic signals to the distance between the wideband acoustic transmitter 14 and the object 12. The shorter the distance between the wideband acoustic transmitter 14 and the object 12, the more acoustic signals can be transmitted and received. The more acoustic signals that can be transmitted and received, the more acoustic data sets can be created. When the structure of an object 12 is inspected for a second time (i.e. the data is reacquired), the apparatus 10 focuses on one part of the object within a specific distance range band therefrom. The repetition rate can then be increased to match the maximum object distance range within this range band. Increasing the repetition rate allows more feature measurements at smaller increments in view angle, thereby facilitating feature tracking.

The wideband acoustic signal may include a high beam width when the whole object 12 is required to be insonified.

As described above, the transmitted wideband acoustic signal may include a frequency chirp, or frequency chirps.

The wideband acoustic signal transmitted from the wideband acoustic transmitter 14 can be designed more explicitly given a specific object of interest. For example:
by focusing the pulse energy onto specific regions of the spectra:
   the backscattering echo is maximised.
   the target resonances are maximised.
   the discrimination between this and other targets is maximised.
The delay between chirps in a multi-chirp pulse can be matched to the spacing between principal target scatterers allowing:
   fine measurement between target scatterers (precision within 10th of lambda=c/f).
   maximising the echo strength by constructive interferences.
   maximising the discrimination between this and other targets (other targets with different spacing between scatterers will cause destructive interferences).

The wideband acoustic receiver 16 of the apparatus 10 receives the acoustic signals returned from the object 12 (and environment). These may be termed echoes, echo structures, or wideband echo structures. The echo structures can come from natural resonances of the object 12 or from responses of the object 12 within some wide band of frequencies which gives discriminatory information for a particular object. The returned signals have a “signature” that is characteristic of the object 12 and/or its contents. The echo structures are a result of multiple physical acoustic processes occurring when the object 12 is insonified by the wideband acoustic signal, including specular echo, scattered reflection, diffraction, inner resonances and scattering including surface waves, roughness scattering and acoustic interaction with the environment. When the object 12 is the seabed, wideband responses gives sediment physical properties, e.g. grain size and hardness, and can be calibrated to give true measurements against known physical backscatter responses.

Where the object is large, or may be heavily layered, or may comprise layers formed in dense materials and/or has a high degree of surface roughness, very low frequencies may be required in a focussed form. In this case parametric acoustic techniques may be used and the wideband acoustic transmitter 14 may include high performance materials, such as single-crystal transducers, to achieve the required bandwidth in a controlled fashion to elicit the required information.

Each of these will distort the incoming acoustic signal via amplitude attenuation, phase delay and signal distortion. These variations are frequency dependent. Within the full echo structure all these contributions interact with one another creating a complex but characteristic acoustic interference pattern. Sub-echo interactions are a function of the geometry of the object 12, dimensions of the object 12 and the physical properties of each of its parts. The wideband acoustic signal, or signals, transmitted by the wideband acoustic transmitter 14 of the apparatus 10 are designed to emphasise the bandwidth in which all of these sub-echoes interact in a tractable way. For example, if the bandwidth is too low, the full echo interference pattern is limited and no, or limited, variations are observed. If the bandwidth is too high, the interference effects vary too rapidly and are then unstable. In the limit only speckle noise is observed.

Object recognition, identification and classification may be considered an inverse problem. Given the object echo, the structure, composition and content may be inferred. This inverse problem has a high dimensionality, which may be solved by using wideband acoustic signals. Due to the nature and high complexity of the problem (3-D structure, different materials with different sound speeds and densities), the inverse problem can be tackled in different ways: (i) knowing the general structure and geometry of a particular object, one can determine the physical properties of at least one of its components (e.g. material, inner content etc.), (ii) knowing the material of the object, one can infer its structure, and (iii) with no prior information but analytical data and/or empirical data of a representative subset of objects of interest for training one can infer both geometry and physical properties.

The transmission of single wideband acoustic signals (“single ping”) may be used when good signal-to-noise ratio (SNR) is available. The transmission of multiple wideband acoustic signals (“multi ping”) may involve integrating the returned echo structures, where the returned echo structures are integrated with aspect and/or temporally and/or spatially and/or ergodically to maximise information gain.

The wideband acoustic receiver 16 receives the returned signals from the object 12 and acoustic data sets are created therefrom. The acoustic data set comprises at least one of the following features of the wideband acoustic signal returned from the object 12: frequency, amplitude, phase delay, phase shift, distortion and shape of signal envelope in time domain. Where the acoustic data set comprises two or more wideband acoustic signals returned from the object 12 (i.e. multiple echoes—primary and secondary echoes), the acoustic data set comprises at least one of the following features of each wideband acoustic signal returned from the object: time delay, phase shift, relative frequency and relative amplitude. The acoustic data set may also comprise the shape of signal envelope in the time domain of the wideband acoustic signal returned from the object 12.

The acoustic data set contains unprocessed data, which may be termed “raw” data. That is, the acoustic data analysed in the method has undergone no signal processing. The acoustic data set may be complete “raw” data, or at least one “sub-band” of “raw” data. Where extraction of a “sub-band” of “raw” data is performed, the characteristics of the acoustic data set are persevered, i.e. the frequency, amplitude, phase delay and distortion characteristics remain unchanged. The wideband acoustic sonar technique described here requires very low noise in the signals, as the raw signal is being processed. There is also no signal (pulse) compression, so there is limited noise rejection. The technique also requires a high sampling frequency, which may be many times the Nyquist frequency.

The apparatus 10, or at least the wideband acoustic transmitter 14 or wideband acoustic receiver 16 thereof, may be moved relative to the object 12 during the transmission and reception of the wideband acoustic signal. In this arrangement a plurality of wideband acoustic signals may be transmitted and received by the apparatus 10 as it moves relative to the object 12. The apparatus 10 may move in a linear path relative to the object 12. Additionally, or alternatively, the apparatus 10 may rotate around the object 12. The apparatus 10 may carry out multiple passes or revolutions about the object 12. The operation may therefore create a plurality of acoustic data sets, e.g. first, second, third and so on.

In this arrangement a plurality of acoustic data sets may be created from the received wideband acoustic signals from the object 12 as the apparatus 10 moves relative to the object 12. Each acoustic data set may contain its own unique information concerning the returned wideband acoustic signal from the object 12. The analysis of each acoustic data set may be used to build up sufficient information to determine the structure of the object 12. This builds up successive acoustic data sets, with each acoustic data set having a different “view” of the object 12.

The system control unit 18 may be used to assess the condition of the data quality of the acoustic data set as the apparatus 10 is moved relative to the object 12. Depending on the condition of the data quality, the system control unit 18 may adapt or modify the wideband acoustic signals transmitted from the wideband acoustic transmitter 14. That is, the system control unit 18 may vary or modify the wideband signal in terms of its frequency, amplitude, transmission time or beam angle, or beam width, during the transmission and reception of the acoustic signals. The data quality can be assessed on-the-fly so that the transmitted signals can be intelligently adapted to increase the information content of the received echoes.

When an unknown object is inspected for the first time, the extracted features give a first estimate on its dimensions and echo return density. These give rough estimates of parameter ‘a’ (the characteristic dimension of the object) so that the outgoing pulse can be dynamically redesigned to match more appropriately the k.a band useful for the algorithms.

The apparatus 10 may therefore modify the wideband acoustic signal transmitted from the wideband acoustic transmitter 14 in dependence on the results obtained from the analysis of the, or each, acoustic data set. In this arrangement the at least one, or each, wideband acoustic signal may be intelligently adapted to optimise the method of determining the at least part of the structure of the object. The wideband acoustic signal may be modified by varying any one, or all, of the frequency, amplitude, transmission time and beam angle, or beam width, of the wideband acoustic signal, as described above. The apparatus 10 may therefore (i) transmit a first wideband acoustic signal, (ii) analyse the first acoustic data set created from the signals returned from the object 12, (iii) modify the wideband acoustic signal to be transmitted from the transmitter 14 in dependence on the first acoustic data set, (iv) transmit a second (modified) wideband acoustic signal, and (v) analyse the second acoustic data set created from the signals returned from the object 12. As described above, the modification of the transmitted signal can be continuously carried out during transmission and reception of the apparatus 10. Similarly, it should be appreciated that the signals transmitted by the apparatus 10 may be the full wideband signal, or a sub-band of this full wideband signal.

The acoustic data sets may be stored on the apparatus 10, or stored in the external data storage device 20.

Data from the acoustic data sets is then analysed to form image data of the structure of the object. This image data is then used to form an image of the structure of the object, which may be displayed to a user either at the apparatus 10, or at a remote image viewing device (not illustrated).

The analysis of the acoustic data sets to determine the structure of the object 12 may include analysing at least one of the frequency data, amplitude data, phase delay data, time delay data and distortion data contained therein. This analysis includes the use of one or more algorithms. The algorithms may include time-domain algorithms, frequency-domain algorithms, time-frequency spaces algorithms, fractional-domain algorithms, or a combination of time-domain algorithms, frequency-domain algorithms, time-frequency spaces algorithms or fractional-domain algorithms. The structure of the object 12 may be determined from the time domain structure of the acoustic data set, the frequency domain structure over time of the acoustic data set, or the frequency domain structure over aspect of the acoustic data set. The analysis therefore comprises the further step of analysing the acoustic data set to determine the time domain structure, the frequency domain structure over time, or the frequency domain structure over aspect.

The analysis of the acoustic data sets may also include identifying one or more common features between data sets. This may include the comparing, fusing, or tracking each common feature between data sets. This may involve the use of “adaptive thresholds” and “min-max” approaches. This may also involve the use of Kalman filters, extended Kalman filters, Markov models, Markov chain Monte Carlo methods, state-space models, particle filters, finite set methods, multi-hypothesis trackers.

The analysis of each acoustic data set may also include identifying the following features from the, or each, acoustic data set: (i) time domain: relative amplitudes, phase delays, time delays between returned acoustic wideband signals, signal distortions; (ii) frequency domain: relative spectral amplitudes, relative phase, wavelet features, scattering operator features, spectral texture features, including positions and scales of peaks and notches, relative positions and scales of peaks and notches and co-occurrence features. The frequency domain features may be analysed for the full frequency band. Additionally, or alternatively, the frequency domain features may be analysed for one or more sub-bands of the full frequency band.

The analysis of each acoustic data set may include fusing and tracking data across a plurality of data sets. The data sets may be classified or compared to one or more of: feature values generated from other wideband “training” data, which may be empirical, real-time, modelled (analytic, numerical) or legacy data. Alternatively an inversion method can be applied: using any available prior information (if available) or information generated from features (as above) to relate the observed responses to the physical processes of echo formation which are in turn determined by the structure (as previously defined) of the object and/or environment/seabed and the known transmission pulse.

The analysis of the acoustic data sets may include comparing the at least one acoustic data set with one or more predetermined, or known, acoustic data sets. The one or more predetermined, or known, acoustic data sets may include empirical data, previously gathered data (legacy data), or data obtained from mathematical modelling.

The system control unit 18 may include a computer for carrying out the analysis of the acoustic data. The computer may have one or more computer programs that correspond to the above-mentioned algorithms and data processing techniques. In this case, the analysis may be carried out in real time. Alternatively, the analysis may be carried out remotely at a later date, or “off line”.

As described above, the operation of the apparatus 10 may include the adaptation or modification of the transmitted wideband acoustic signal in dependence on the results obtained from the analysis of the acoustic data sets. In this arrangement the transmitted wideband acoustic signal may be intelligently adapted to optimise the determination of the structure of the object.

The analysis techniques, processes and steps are used to extract the information necessary to determine the, or at least part of, the structure of the object 12. This may be termed the “wideband sonar image”. This information may be presented to a user of the apparatus through, for example, a graphical user interface (GUI). The information presented to the user may include smart colour sonar imaging, which includes additional contextual image information superimposed onto the sonar image, such as seabed type, man-made object, object defects, or the like.

Once the, or at least part of, the structure of the object 12 has been determined it is also possible to determine the identity of the object, i.e. to determine what the object 12 is. This may be carried out be determining a plurality of parts of the structure of the object 12. Similarly, the object 12 may also be classified, i.e. to determine what class of object the object 12 falls within. Similarly, the analysis of the, or at least part of, the structure of the object 12 may also include assessing the condition of the object 12. This may comprise determining a plurality of parts of the structure of the object, and optionally comparing this with predetermined, or known, data on the part of the structure.

Where the object 12 includes a number of different parts, or components, the analysis may determine at least a part of the structure of each part, or component, of the object. If the object 12 contains, or filled with, a solid, liquid or gas, the analysis may determine at least a part of the structure of the object 12 and the material contained therein.

As described above, the object may be an area of land, such as the seabed. In this case the analysis may determine at least a part of the structure of the seabed, such as physical properties of the sediment, surface hardness, grain size of sand, layering information, surface roughness and topographical information.

The object may be any one of, or combination of, the following: a manmade object or a natural object, such as a seabed or environment.

It is also possible to determine the location, or geolocation of the at least part of the structure of the object 12 and log these data.

The wideband system of the present invention is fundamentally different to other sonar, or imaging, systems in recording and analyzing raw echoes. Other sonars use predominantly echo intensity and process the matched-filtered (compressed) echoes. These known procedures destroy the information the WBS uses for object identification and classification.

The applications of the apparatus 10 are in the fields of: object detection and recognition; automatic target recognition; pipeline and cable tracking; pipeline and cable monitoring; structural integrity monitoring; flooded member detection; flooded annulus detection; identification of contents of underwater objects and structures; fisheries identification and assessment; environmental impact assessment and monitoring; and seabed survey and classification. All of these benefit from improved information available through wideband echo structures. The wideband echo structures from the transmission of single wideband acoustic signals (single pings) are used directly in cases where good SNR is available. In other cases returns can be integrated with aspect and/or temporally and/or spatially and/or ergodically to maximise information gain.

The present invention uses wideband responses from underwater objects to enable true recognition, rather than inference from matched filtered intensity data, as used in “narrowband” systems and systems relying on pulse compression. The full wideband response includes all of the information about an object, e.g. structure, contents, materials, surface roughness wall thicknesses etc. Narrowband sonar and simple intensity based data do not provide this. Other sonar systems are geared towards imaging and process matched filtered (compressed echoes). Other systems have been designed to improve resolution through better pulse compression. The solution presented in the present application performs object structure determination directly from processing the raw wideband response, rather than simply examining the intensity. Objects of similar dimensions, shapes and target strengths are indistinguishable in sonar records using conventional systems, whereas all of these factors produce different wideband signatures, which can be interpreted by the system of the present invention to give more accurate structure determination that other systems. Another important difference between the present invention and known systems is that the system of the present invention uses different wideband acoustic signals (pulses) depending on the environment that the apparatus 10 is operating and the specific task it is being used for, i.e. what type of object it is looking for.

Modifications and improvements may be made to the above without departing from the scope of the present invention. For example, although the apparatus 10 has been illustrated and described above as being used in a volume of water, it should be appreciated that the apparatus 10 may be capable of operating in a solid, liquid or gaseous medium. The apparatus 10 may be “non-contact” in these modes of operations.

Furthermore, although the transducer element has been described above as being a circular-shaped arrangement, it should be appreciated that the transducer element may be any other suitable shape, such as rectangular-shape, hexagonal-shape etc.

Also, it should be appreciated that, in addition to the range of frequencies described above, the transmitted at least one wideband acoustic signal may have a frequency range between approximately 1 kHz and 10 kHz, 1 kHz and 30 kHz, 5 kHz and 50 kHz, 20 kHz and 200 kHz, 100 kHz or 1 MHz.

1. A method of determining at least part of the structure of an object, the method comprising the steps of:
providing at least one wideband acoustic signal transmission and reception device, the at least one wideband acoustic signal transmission and reception device being capable of transmitting and receiving one or more wideband acoustic signals;
using the at least one wideband acoustic signal transmission and reception device to transmit at least one wideband acoustic signal towards at least a portion of the object;
using the at least one wideband acoustic signal transmission and reception device to receive at least one wideband acoustic signal from the object;
using the received at least one wideband acoustic signal from the object to create at least one acoustic data set; and
analysing the at least one acoustic data set to determine the at least part of the structure of the object.

2. The method of claim 1, wherein the at least one wideband acoustic signal transmission and reception device has a Q factor of less than 2.0.

3. The method of claim 1, wherein the at least one wideband acoustic signal transmission and reception device is capable of transmitting and receiving wideband acoustic signals at more than 1 octave, 2 octaves, or 3 octaves.

4. The method of claim 1, wherein the transmitted at least one wideband acoustic signal has a frequency range between approximately 1 kHz and 2.5 MHz.

5. (canceled)

6. The method of claim 1, wherein the transmitted at least one wideband acoustic signal has a beam angle, or beam width, of between approximately 10 degrees to 120 degrees.

7. (canceled)

8. The method of claim 1, wherein the transmitted at least one wideband acoustic signal has a wave number k, where k=2π/λ, or k=2πf/c, and where λ is the wavelength of the acoustic signal in the material in which the acoustic signal is travelling, c is the speed of the acoustic signal in the material in which the acoustic signal is travelling, and f is the frequency of the acoustic signal in the material in which the acoustic signal is travelling, and the transmitted at least one wideband acoustic signal is transmitted in the range of k.a of between 5 and 100 ([5:100]), where a is a dimension of the object.

9. The method of claim 8, wherein the method includes the further step of selectively optimising the k.a range of the at least one wideband acoustic signal in dependence on at least one predetermined, or known, feature of the object, or the environment in which the object is located.

10-11. (canceled)

12. The method of claim 1, wherein the method comprises the further step of selectively optimising any one, or all, of the frequency, amplitude, transmission time and beam angle, or beam width, of the at least one wideband acoustic signal in dependence on at least one predetermined, or known, feature of the object, or the environment in which the object is located.

13. The method of claim 1, wherein the at least one wideband acoustic signal is focussed onto selected regions of the spectra.

14-15. (canceled)

16. The method of claim 1, wherein the at least one wideband acoustic signal transmission and reception device includes a transmission wideband acoustic signal transducer and a reception wideband acoustic signal transducer.

17. The method of claim 16, wherein the transmitting transducer and the receiving transducer are at the same location with respect to the object, or at different locations with respect to the object.

18. The method of claim 16, wherein the transmitting or receiving transducer is located adjacent, or within, the object.

19. (canceled)

20. The method of claim 16, wherein the at least one wideband acoustic signal transmission and reception device includes a plurality of transmission wideband acoustic signal transducers and a plurality of reception wideband acoustic signal transducers.

21. The method of claim 1, wherein the at least one wideband acoustic signal transmission and reception device is capable of transmitting and receiving a plurality of wideband acoustic signals.

22. The method of claim 21, wherein the at least one wideband acoustic signal transmission and reception device is capable of transmitting a plurality of wideband acoustic signals repeatedly.

23-24. (canceled)

25. The method of claim 21, wherein the at least one wideband acoustic signal transmission and reception device is configurable to select which of the plurality of transmission and reception wideband acoustic signal transducers are used to transmit and receive the plurality of wideband acoustic signals.

26-28. (canceled)

29. The method of claim 1, wherein the received at least one wideband acoustic signal from the object is used to create two or more acoustic data sets.

30. The method of claim 1, wherein the method comprises the further step of moving the at least one wideband acoustic signal transmission and reception device relative to the object during the transmission and reception of the at least one wideband acoustic signal.

31. The method of claim 1, wherein the method comprises the further step of analysing the at least one acoustic data set to form image data of the at least part of the structure of the object.

32. (canceled)

33. The method of claim 1, wherein the step of analysing the at least one acoustic data set to determine the at least part of the structure includes analysing at least one of the frequency data, amplitude data, phase delay data, time delay data and distortion data contained therein.

34. (canceled)

35. The method of claim 1, wherein the at least part of the structure of the object is determined from the time domain structure of the acoustic data set, the frequency domain structure over time of the acoustic data set, or the frequency domain structure over aspect of the acoustic data set.

36. The method of claim 29, wherein the step of analysing the acoustic data set to determine the at least part of the structure includes identifying one or more common features between data sets.

37. The method of claim 36, wherein the step of analysing each acoustic data set to determine the at least part of the structure includes comparing, fusing, or tracking each common feature between data sets.

38. The method of claim 1, wherein the step of analysing each acoustic data set to determine the at least part of the structure includes identifying the following features from the acoustic data set: (i) time domain: relative amplitudes, phase delays, time delays between returned acoustic wideband signals, signal distortions; (ii) frequency domain: relative spectral amplitudes, relative phase, wavelet features, scattering operator features, spectral texture features, including positions and scales of peaks and notches, relative positions and scales of peaks and notches and co-occurrence features.

39. The method of claim 36, wherein the data sets are classified or compared to one or more of: feature values generated from other wideband “training” data, which may be empirical, real-time, modelled (analytic, numerical) or legacy data. The features are classified or compared to one or more of: feature values generated or collated from other wideband ‘training’ data: empirical, real-time (in-situ), modelled (analytic, numerical), legacy data. Alternatively an inversion method can be applied: using any available prior information (if available) or information generated from features (as above) to relate the observed responses to the physical processes of echo formation which are in turn determined by the structure (as previously defined) of the object and/or environment/seabed and the known transmission pulse.

40. (canceled)

41. The method of claim 1, wherein the method comprises the further step of modifying the at least one wideband acoustic signal transmitted from the at least one wideband acoustic signal transmission and reception device in dependence on the results obtained from the analysis of the at least one acoustic data set.

42. The method of claim 41, wherein the method comprises the steps of (i) transmitting a first wideband acoustic signal, (ii) analysing a first acoustic data set created from the wideband acoustic signals returned from the object, (iii) modifying the at least one wideband acoustic signal transmitted from the at least one wideband acoustic signal transmission and reception device in dependence on the first acoustic data set, (iv) transmitting a second (modified) wideband acoustic signal from the at least one wideband acoustic signal transmission and reception device, and (v) analysing a second acoustic data set created from the wideband acoustic signals returned from the object.

43. The method of claim 42, wherein the method comprises the further step of continuously analysing the acoustic data sets and modifying the at least one wideband acoustic signal transmitted from the at least one wideband acoustic signal transmission and reception device in dependence on the content of the acoustic data set.

44. The method of claim 42, wherein the method comprises the further step of intelligently adapting the at least one wideband acoustic signal to optimise the method of determining the at least part of the structure of the object.

45. The method of claim 1, wherein, when the object includes a number of different parts, or components, the method determines at least a part of the structure of each part, or component, of the object.

46. The method of claim 1, wherein the object is an area of land, or part of the seabed.

47-87. (canceled)

88. A wideband acoustic signal transmission and reception device comprising:
at least one transducer element having a plurality of array elements, wherein each array element is configurable to transmit or receive at least one wideband acoustic signal; and
at least one filtering module, the at least one filtering module being operable with at least one array element to filter a transmitted wideband acoustic signal therefrom or a received wideband acoustic signal thereto.

89. A wideband acoustic signal transmission and reception device according to claim 88, wherein the at least one filtering module is selectively operable with each array element of the transducer element.

90-92. (canceled)

93. A wideband acoustic signal transmission and reception device according to claim 90, wherein the at least one filtering module includes one or more phase preservation frequency dependent filters.

94. (canceled)

95. A wideband acoustic signal transmission and reception device according to claim 91, wherein the at least one filtering module includes one or more frequency dependent filters, wherein the one or more frequency dependent filters include discrete electrical components, and the at least one filtering module is operable to assign a specific frequency-dependent filter to each array element.

96. A wideband acoustic signal transmission and reception device according to claim 95, wherein each array element includes a specific, or unique, frequency-dependent filter.

97. A wideband acoustic signal transmission and reception device according to claim 88, wherein the at least one transducer element is arranged such that the array elements include a central portion of array elements and a peripheral portion of array elements.

98. (canceled)

99. A wideband acoustic signal transmission and reception device according to claim 98, wherein the at least one transducer element includes a plurality of concentric ring-shaped peripheral portions, each portion being concentric with the central portion, and wherein the central portion of the array element is circular shaped.

100. (canceled)

101. A wideband acoustic signal transmission and reception device according to claim 92, wherein at least one filtering module includes one or more frequency-dependent filters, wherein the frequency dependent filters include digital filters, wherein the at least one filtering module is operable to filter transmitted and/or received wideband acoustic signals from one or more selected array elements within the array.

102. A wideband acoustic signal transmission and reception device according to claim 92, wherein at least one filtering module includes one or more frequency-dependent filters, wherein the frequency dependent filters include digital filters, wherein the at least one filtering module is operable to filter transmitted and/or received wideband acoustic signals from groups of array elements that are equidistant from a centre of the array.

103. A wideband acoustic signal transmission and reception device according to claim 101, wherein the wideband acoustic signal transmission and reception device further includes a computer, wherein the computer includes software capable of operating the filtering module to filter the transmitted and received wideband signals with the digital filters and to sample and record digital data therefrom.

104. A wideband acoustic signal transmission and reception device according to claim 88, wherein the at least one filtering module includes one or more time-varying filters, or range-dependent filters.

105-113. (canceled)

114. A method of determining at least one of a physical property and a geometric property of an object, the method comprising the steps of:
providing at least one wideband acoustic signal transmission and reception device, the at least one wideband acoustic signal transmission and reception device being capable of transmitting and receiving one or more wideband acoustic signals;
using the at least one wideband acoustic signal transmission and reception device to transmit at least one wideband acoustic signal towards at least a portion of the object;
using the at least one wideband acoustic signal transmission and reception device to receive at least one wideband acoustic signal from the object;
using the received at least one wideband acoustic signal from the object to create at least one acoustic data set; and
analysing the at least one acoustic data set to determine at least one of the physical property and the geometric property of the object.

115. (canceled)
